(19) United States
(12) Patent Application Publication
(10) Pub. No.: US 2026/0094468 A1
(43) Pub. Date: Apr. 2, 2026

(54) MAKEUP EXTRACTION METHOD AND APPARATUS, DEVICE, MEDIUM, AND PRODUCT

(71) Applicant: Beijing Zitiao Network Technology Co., Ltd., Beijing (CN)

(72) Inventors: Zhixing CHEN, Beijing (CN); Jizhe XIA, Beijing (CN); Bowen CHEN, Beijing (CN); Huichao ZHANG, Beijing (CN); Yuan GAO, Beijing (CN); Kang DU, Beijing (CN); Chengcheng YANG, Beijing (CN)

(21) Appl. No.: 19/344,021

(22) Filed: Sep. 29, 2025

(30) Foreign Application Priority Data
Sep. 30, 2024 (CN) 202411391523.3

(51) Int. Cl. G06V 40/16; G06T 11/60; G06V 10/74; G06V 10/774

(52) U.S. Cl. CPC G06V 40/171; G06T 11/60; G06V 10/761; G06V 10/774

(57) ABSTRACT

The present application discloses a makeup extraction method and apparatus, a device, a medium, and a product. The method includes: first obtaining a target image, wherein the target image includes a first face and a makeup for decorating the first face; then, processing the target image using a first model, to obtain a first predicted makeup, wherein the first predicted makeup can describe some makeup details in the target image; then, processing the target image and the first predicted makeup using a second model, to obtain a second predicted makeup, wherein the second predicted makeup can more comprehensively and more accurately describe makeup details in the target image; and finally, determining a makeup extraction result of the target image based on the second predicted makeup.

### CROSS-REFERENCE TO RELATED APPLICATION(S)

This application claims priority to Chinese Application No. 202411391523.3 filed Sep. 30, 2024, the disclosure of which is incorporated herein by reference in its entirety.

### FIELD

The present application relates to the technical field of data processing, and in particular, to a makeup extraction method and apparatus, a device, a medium, and a product.

### BACKGROUND

For some scenarios, such as a makeup recognition scenario, a makeup transfer scenario, or a makeup replication scenario, there may be a following requirement: performing makeup extraction on an image to obtain a makeup of a face in that image.

### SUMMARY

The present application provides a makeup extraction method and apparatus, a device, a medium, and a product, which are favorable for enhancing a makeup determining effect.

To implement the above objectives, technical solutions provided by the present application are as follows:

The present application provides a makeup extraction method. The method includes: obtaining a target image, wherein the target image includes a first face and a makeup for decorating the first face; processing the target image using a first model to obtain a first predicted makeup; processing the target image and the first predicted makeup using a second model to obtain a second predicted makeup; and determining a makeup extraction result of the target image based on the second predicted makeup.

In a possible implementation, the second predicted makeup is an optimization result of the first predicted makeup.

In a possible implementation, the second predicted makeup satisfies at least one of the following constraints: a quantity of details described by the second predicted makeup is larger than a quantity of details described by the first predicted makeup; for any detail of the makeup in the target image, an accuracy of the detail in the second predicted makeup is greater than an accuracy of the detail in the first predicted makeup; and for any detail of the makeup in the target image, a similarity between a state of the detail in the second predicted makeup and a state of the detail in the target image is greater than a similarity between a state of the detail in the first predicted makeup and the state of the detail in the target image.

In a possible implementation, a process of determining the second predicted makeup includes: initializing input data of the second model based on the target image and the first predicted makeup; processing the input data of the second model using the second model, to obtain output data of the second model, wherein the output data is used for describing a predicted makeup of the first face in the target image; and updating the input data of the second model based on the output data of the second model, continuing to perform the step of processing the input data of the second model using the second model, and determining the second predicted makeup based on the output data of the second model when an iteration stop condition is satisfied.

In a possible implementation, the iteration stop condition includes at least one of the following conditions: a number of iterations reaches a preset number-of-times threshold, the number of iterations being in positive correlation with a number of times of use of the second model; a change rate of the output data of the second model is less than a first change rate threshold; and a change rate of a difference between the output data of the second model and the first predicted makeup is less than a second change rate threshold.

In a possible implementation, before the initializing input data of the second model, the method further includes: initializing a target makeup using the first predicted makeup, wherein the initializing input data of the second model based on the target image and the first predicted makeup includes: determining the input data of the second model based on the target image and the target makeup; and the updating the input data of the second model based on the output data of the second model, and continuing to perform the step of processing the input data of the second model using the second model includes: updating the target makeup based on the output data of the second model, and continuing to perform the step of determining the input data of the second model based on the target image and the target makeup.

In a possible implementation, the target makeup includes at least one image; the at least one image is used for describing the predicted makeup of the first face in the target image; and the process of determining the input data of the second model includes: concatenating the target image using the target makeup to obtain a concatenated result, wherein a number of channels of the concatenated result is determined based on a sum of a number of channels of the target image and a number of channels of the at least one image; and performing convolution processing on the concatenated result to obtain the input data of the second model, wherein a number of channels of the input data of the second model satisfies a number-of-channel constraint of the second model.

In a possible implementation, the first model and the second model satisfy at least one of the following constraints: a network structure of the first model is the same as a network structure of the second model, and a network parameter of the first model is different from a network parameter of the second model; input data of the first model and the input data of the second model both do not include a randomly generated noise image; and a processing process implemented using the first model and a processing process implemented using the second model both do not include a process of performing denoising in a random direction.

In a possible implementation, the makeup extraction result is obtained by processing the target image by a makeup extraction model; the makeup extraction model includes the first model and the second model; and a process of training the makeup extraction model includes: training the first model in the makeup extraction model using the first image and label information corresponding to the first image, wherein the first image includes a second face and a makeup for decorating the second face; the label information corresponding to the first image is used for describing an actual makeup of the second face in the first image; and training the second model in the makeup extraction model using the second image and label information corresponding to the second image, wherein the second image includes a third face and a makeup for decorating the third face; the label information corresponding to the second image is used for describing an actual makeup of the third face in the second image.

In a possible implementation, a process of training the first model includes: processing the first image using the first model, to obtain predicted information corresponding to the first image, wherein the predicted information is used for describing a predicted makeup of the second face in the first image; and updating the first model in the makeup extraction model based on a difference between the predicted information corresponding to the first image and the label information corresponding to the first image.

In a possible implementation, the method further includes: converting the predicted information corresponding to the first image from a first color space to a second color space, to obtain a predicted conversion result corresponding to the first image, and converting the label information corresponding to the first image from the first color space to the second color space, to obtain a label conversion result corresponding to the first image; and the updating the first model in the makeup extraction model based on a difference between the predicted information corresponding to the first image and the label information corresponding to the first image includes: updating the first model in the makeup extraction model based on a difference between the predicted conversion result corresponding to the first image and the label conversion result corresponding to the first image.

In a possible implementation, a process of training the second model includes: processing the second image using the first model, to obtain first predicted information corresponding to the second image, wherein the first predicted information is used for describing a predicted makeup of the third face in the second image; and processing the second image and the first predicted information using the second model, to obtain second predicted information corresponding to the second image, wherein the second predicted information is used for describing a predicted makeup of the third face in the second image; and updating the second model in the makeup extraction model based on a difference between the second predicted information and the label information corresponding to the second image.

In a possible implementation, the method further includes: converting the second predicted information from a first color space to a second color space, to obtain a conversion result corresponding to the second predicted information, and converting the label information corresponding to the second image from the first color space to the second color space, to obtain a label conversion result corresponding to the second image; and the updating the second model in the makeup extraction model based on a difference between the second predicted information and the label information corresponding to the second image includes: updating the second model in the makeup extraction model based on a difference between the conversion result corresponding to the second predicted information and the label conversion result corresponding to the second image.

In a possible implementation, the updating the second model in the makeup extraction model based on a difference between the second predicted information and the label information corresponding to the second image includes: updating the second model in the makeup extraction model based on a difference between the second predicted information and the label information corresponding to the second image, and a difference between the second predicted information and the first predicted information.

In a possible implementation, the makeup extraction model is trained based on a training dataset; the training dataset includes a plurality of sample images; the plurality of sample images include the first image and the second image; for any sample image, a process of determining the sample image and label information corresponding to the sample image includes: performing image generation using an image generation model, to obtain a generated image, wherein the generated image includes a fourth face, and the generated image does not include a makeup for decorating the fourth face; and superimposing at least one makeup material obtained from a pre-built makeup library to the generated image, to obtain the sample image, and determining the label information corresponding to the sample image according to the at least one makeup material, wherein different makeup materials are used for decorating different face regions.

In a possible implementation, a process of building the makeup library includes: obtaining a plurality of makeup effects from at least one application; for any makeup effect, adjusting at least one dimension of the makeup effect to obtain an adjustment result, wherein the at least one dimension includes a color and/or a transparency; and building the makeup library based on the plurality of makeup effects and the adjustment results.

In a possible implementation, the target image is used for describing a makeup of at least one region in the first face; the at least one region includes one or more of eyelashes, an eye socket, an eyeball, cheeks, and a mouth; the makeup extraction result of the target image includes makeup extraction results of the regions; and after the determining a makeup extraction result of the target image, the method further includes: for any face image, superimposing the makeup extraction results of some or all of regions of the at least one region to the face image, to obtain a superimposed image, wherein makeups of the superimposed image presented in the portion or all of the regions are kept consistent with makeups of the target image presented in the portion or all of the regions.

The present application provides a makeup extraction apparatus, including: a data obtaining unit, configured to obtain a target image, wherein the target image includes a first face and a makeup for decorating the first face; a first processing unit, configured to process the target image using a first model, to obtain a first predicted makeup; a second processing unit, configured to process the target image and the first predicted makeup using a second model, to obtain a second predicted makeup; and a data determining unit, configured to determine a makeup extraction result of the target image based on the second predicted makeup.

The present application provides an electronic device, including a processor and a memory, wherein the memory is configured to store an instruction or a computer program; and the processor is configured to perform the instruction or the computer program in the memory to cause the electronic device to perform the makeup extraction method of the present application.

The present application provides a computer-readable medium, having an instruction or a computer program stored therein, wherein the instruction or the computer program, when run on a device, causes the device to perform the makeup extraction method of the present application.

The present application provides a computer program product, including a computer program carried on a non-transient computer-readable medium. The computer program includes program codes used for performing the makeup extraction method of the present application.

### BRIEF DESCRIPTION OF THE DRAWINGS

To describe the technical solutions in the embodiments of the present application or in the related art more clearly, the following briefly introduces the accompanying drawings for describing the embodiments or the related art. Apparently, the accompanying drawings in the following description show merely some embodiments recorded in the present application, and a person of ordinary skill in the art may still derive other drawings from the accompanying drawings without creative efforts.

FIG. 1 is a flowchart of a makeup extraction method according to an embodiment of the present application;

FIG. 2 is a schematic diagram of a makeup extraction flow according to an embodiment of the present application;

FIG. 3 is a schematic structural diagram of a Transformer-based model according to an embodiment of the present application;

FIG. 4 is a schematic diagram of a process of training a first model according to an embodiment of the present application;

FIG. 5 is a schematic diagram of a process of training a second model according to an embodiment of the present application;

FIG. 6 is a schematic structural diagram of a makeup extraction apparatus according to an embodiment of the present application; and

FIG. 7 is a schematic structural diagram of an electronic device according to an embodiment of the present application.

### DETAILED DESCRIPTION OF EMBODIMENTS

In order to make a person skilled in the art to better understand the solutions of the present application, the technical solutions in the embodiments of the present application are clearly and completely described below with reference to the accompanying drawings in the embodiments of the present application. Apparently, the described embodiments are merely some rather than all of the embodiments of the present application. All other embodiments obtained by a person of ordinary skill in the art based on the embodiments of the present disclosure without making creative efforts shall fall within the protection scope of the present disclosure.

However, how to implement makeup extraction is a technical problem that urgently needs to be solved.

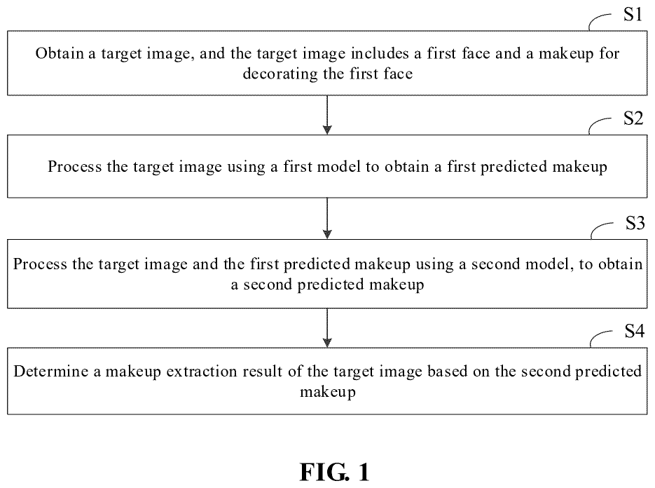

For ease of understanding the technical solutions provided by the present application, the following will make an explanation to a makeup extraction method provided by the present application in conjunction with the accompanying drawings. As shown in FIG. 1, the makeup extraction method according to an embodiment of the present application includes S1 to S4 below. FIG. 1 is a flowchart of a makeup extraction method according to an embodiment of the present application.

S1: A target image is obtained, wherein the target image includes a first face and a makeup for decorating the first face.

A makeup means an object for decorating a face, such as wearing cosmetic contact lenses, putting on blush, and applying lipstick, so that the face decorated by the makeup is in a makeup-wearing state (also referred to as a made-up state). It should be noted that the present application does not limit the implementation of the makeup-wearing state. The makeup-wearing state means an effect presented after applying makeup (such as decorating or making up) to the face.

The target image is an image that requires makeup extraction to make a face presented in the target image in a makeup-wearing state, so that the target image can not only describe both a face and a makeup for decorating the face.

As can be seen, the target image may at least satisfy the following constraints: the target image includes the first face and the makeup for decorating the first face. The first face is a face presented in the target image. The “makeup for decorating the first face” is an object that is presented in the target image and is used for decorating the first face, so that the “makeup for decorating the first face” can reflect an effect implemented after the first face is made up.

In addition, in some scenarios, in order to improve the flexibility, the target image may satisfy at least the following constraints: the target image is used for describing a makeup of at least one region in the first face, and the at least one region includes one or more of eyelashes, an eye socket, an eyeball, cheeks, and a mouth. The at least one region is a region that exists on the face described by the target image and can be decorated by makeup, such as the eyelash, the eye socket, the eyeball, the cheeks, and the mouth.

In addition, the present application does not limit the determining method for the at least one region in the preceding paragraph, for example, the at least one region may be designated by relevant personnel in advance.

Furthermore, in order to improve the flexibility, the present application further provides a determining method for the above at least one region, which may specifically include step 11 to step 12 below.

Step 11: A plurality of makeup effects are obtained from at least one application.

The application is used for providing a user with some makeup effects, so that the user can use the makeup effects for face decoration. Moreover, the present application does not limit the application. For example, the application may be determined according to an actual application scenario.

The makeup effects are used for decorating the face. Moreover, the present application does not limit an implementation of the makeup effects. For example, existing or future makeup effects with face decoration functions may be used, for example, for adjusting a lip color, adjusting an eyeball color, adjusting eyelashes shape, or the like.

In addition, the present application does not limit the implementation of step 11 above. For example, any existing or future method that can obtain the makeup effects from some applications can be used for implementation.

Step 12: the above at least one region is determined according to decoration targets of the makeup effects.

For any makeup effect, the decoration target of the makeup effect is a face region decorated by the makeup effect, such as the eyelash, the eye socket, the eyeball, the cheeks, or the mouth.

In addition, the present application does not limit the implementation of step 12 above. For example, this step may specifically be: performing statistical analysis on decoration targets of a plurality of makeup effects, to obtain the above at least one region. The at least one region includes the decoration targets of the makeup effects, thereby enabling the at least one region to fully cover the decoration targets of these makeup effects.

Based on the relevant content of step 11 to step 12 above, as can be seen, in some scenarios, some makeup effects may be first obtained from some applications, and these makeup effects can fully represent a face decoration that can be implemented with the help of these applications. The statistical analysis is then performed for the decoration targets of these makeup effects to obtain the above at least one region. The at least one region can represent as comprehensively as possible the face region that can be decorated with these makeup effects. This is beneficial for improving flexibility and accuracy.

Furthermore, the present application does not limit the obtaining method for the above target image. For example, it may include receiving an image provided by a user as the target image.

Through research, it has been found that for an image, if a face described in the image is not a front face, a rotation angle of the face may interfere with a makeup extraction process, thereby affecting a makeup determining effect.

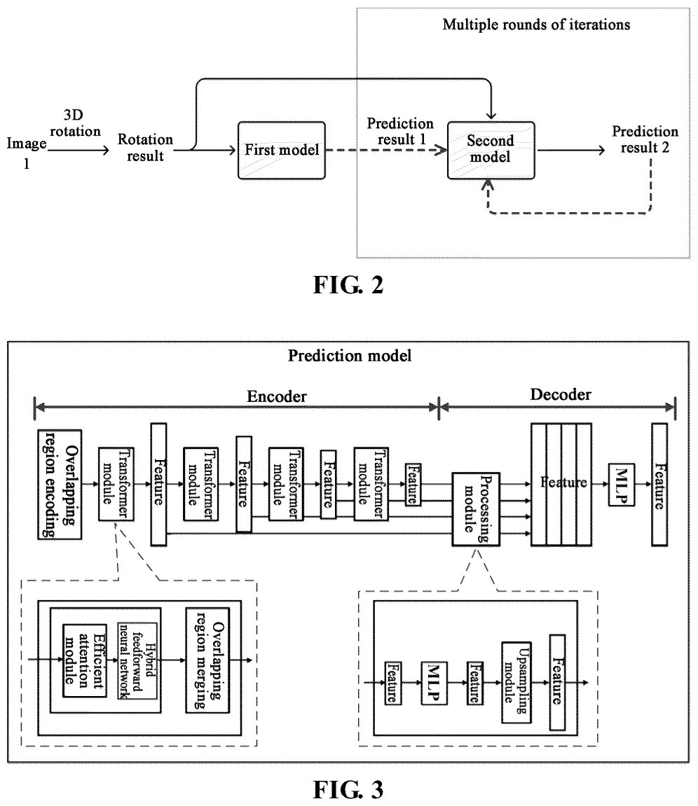

Based on the research in the previous paragraph, in order to better enhance the makeup determining effect, the present application further provides an obtaining method for the above target image, which may be: first receiving an image provided by a user (such as image 1 shown in FIG. 2); then determining whether a face in the image is in a frontal view; if the face is in a frontal view, determining that a rotation angle of the face in the image is 0, thereby determining that the rotation angle may not interfere with the makeup extraction process and directly using the image as the target image; and if the face is not in a frontal view, determining that a rotation angle of the face in the image is not 0, thereby determining that the rotation angle may interfere with the makeup extraction process. Therefore, 3-dimensional (3D) remodeling can be first performed on the image, to obtain a 3D model. The 3D model is used for presenting the face described by the image in a three-dimensional space. Then, a front view of the 3D image is obtained as the target image, so that a rotation angle of a face in the target image is 0, and the face in the target image is in a frontal view.

Through research, it has been found that different faces have different shape features, there may be differences in states represented by the same makeup on different faces. This can interfere with the makeup extraction process and affect the makeup determining effect.

Based on the previous research, in order to better enhance the makeup determining effect, the present application further provides an obtaining method for the above target image, which may include: first receiving an image provided by a user; then determining whether a face in the image is in a frontal view; if the face is in a frontal view, projecting the image onto a pre-specified standard face to obtain the target image, to cause a face presented in the target image to conform to a position constraint described by the standard face; if the face is not in a frontal view, first performing 3D remolding on the image to obtain a 3D model which is used for presenting the face described by the image in a three-dimensional space; and then projecting a front view of the 3D image onto the standard face to obtain the target image, making the face in the target image in the frontal view and making the face presented in the target image conform to a positional constraint described by the standard face. This can effectively avoid interference caused by different shape features of different faces, thereby enhancing the makeup determining effect.

It should be noted that for the standard face mentioned in the previous paragraph, the standard face is a face that is specified in advance and needs to be used during alignment of different faces, so that using the standard face, different face images can be subsequently aligned to a position constrained by the standard face, such as positions of the five sense organs. This ensures that an alignment result satisfies the position constraint described by the standard face, which is beneficial for improving the makeup determining effect.

Based on the relevant content of S1 above, as can be seen, for some scenarios, after the image (such as image 1 shown in FIG. 2) provided by the user is obtained, a 3D face rotation (such as 3D rotation shown in FIG. 2) technology can be used to align the image to the standard face position and obtain the target image (such as a rotation result as shown in FIG. 2), so that the target image can better represent a face makeup. This can effectively avoid interference caused by some factors (such as a rotation angle of the face and a structural characteristic of the face itself, thereby improving the makeup determining effect.

S2: The target image is processed using a first model, to obtain a first predicted makeup.

The first model is a pre-trained machine learning model using a makeup prediction (such as makeup extraction) function, so that the first model can be used for predicting (such as performing makeup extraction on) input data of the first model, so that the present application can use the first model to implement a first stage of processing (such as makeup extraction).

In addition, the present application does not limit the implementation of the above first model above. For example, the first model may be implemented using any existing or future machine learning model with prediction performance.

Through research, it has been found that for some machine learning models, such as any diffusion model, the model has the following defect: Since input data of the model includes a randomly generated noise image, a prediction process implemented using the model has randomness, which leads to a significant difference between a makeup obtained by the prediction process and a makeup presented in a face image input to the model, causing a poor makeup prediction effect.

Based on the research in the previous paragraph, in order to better enhance the makeup determining effect, the present application further provides a possible implementation of the above first model. In this implementation, the first model may at least satisfy the following constraint: Input data of the first model does not include a randomly generated noise image. This can effectively avoid defects caused by the noise image, thus effectively reducing the randomness of the makeup prediction process and enhancing the makeup determining effect.

Through research, it has been found that for some machine learning models, such as any diffusion model, the model has the following defect: Since a generation direction used by a denoising network in the model is randomly selected, a prediction process implemented using the model has randomness, which leads to a significant difference between a makeup obtained by the prediction process and a makeup presented in a face image input to the model, causing a poor makeup prediction effect.

Based on the research in the previous paragraph, in order to better enhance the makeup determining effect, the present application further provides a possible implementation of the above first model. In this implementation, the first model may at least satisfy the following constraint: A processing process (such as the process shown in S2 above) implemented using the first model does not include a process of performing denoising in a random direction. This can effectively reduce the randomness of the makeup prediction process and then enhance the makeup determining effect.

As can be seen, in a possible implementation, in order to better enhance the makeup determining effect, the above first model may be implemented using another machine learning model besides a diffusion model. Another machine learning model does not have the randomness defect presented by the diffusion model itself, so that another machine learning model can effectively overcome the defect caused by the randomness of the diffusion model, which is conducive to enhancing the makeup determining effect.

In addition, the present application does not limit the implementation of another machine learning model in the previous paragraph. For example, another machine learning model may be implemented using any Transformer-based model.

In addition, in order to better reduce overheads, such as time overheads and computing resource overheads, the present application further provides a possible implementation of the above first model. In this implementation, the first model may be implemented using a SegFormer model, such as a prediction model shown in FIG. 3, so that the first model may at least satisfy the following constraints: input data of the first model does not include a randomly generated noise image, and a processing process implemented using the first model does not include a process of performing denoising in a random direction. Since the SegFormer model has low operation time consumption, training and reasoning time of the first model built based on the SegFormer model is low, which is conducive to reducing the time overheads and the computing resource overheads.

It should be noted that the SegFormer model is a Transformer-based deep learning model for semantic image segmentation. Furthermore, this SegFormer model combines the advantages of a Transformer architecture and an efficient convolutional neural network (CNN) characteristic, so that the SegFormer model has low operation time consumption. In addition, the SegFormer includes a layered Transformer encoder and a multilayer perceptron (MLP) decoder. The layered Transformer encoder can process different feature scales and capture a multi-scale feature, and the MLP decoder is configured to process the multi-scale feature obtained from the encoder and generate a final segmentation result, so that the SegFormer performs well in modeling of a long-distance dependency relationship and extraction of the multi-scale feature, thus achieving good performance in a semantic segmentation task. In addition, the layered Transformer encoder represents an encoder of the SegFormer model, and the layered Transformer encoder is implemented using a Transformer with a layered structure, so that each layer in the layered Transformer encoder processes different feature scales to capture the multi-scale feature. This can effectively solve a problem in computation efficiency of the Transformer during high-resolution image processing and maintain high accuracy. Furthermore, the MLP decoder represents a decoder of the SegFormer model, and the MLP decoder uses MLP to process the multi-scale feature obtained from the encoder. The MLP decoder has a simple structure, but can efficiently fuse the multi-scale feature, and is completely based on fully connected layers, thereby reducing computation complexity.

Moreover, the present application does not limit the training method for the above first model. For example, the training may be implemented with any existing or future model training method.

The first predicted makeup is a result obtained by processing the target image by the first model, so that the first predicted makeup can represent a predicted makeup that is determined by the first model and is of the first face in the target image.

In addition, the present application does not limit the representation of the above first predicted makeup. For example, any existing or future method that can represent a makeup may be used for implementation.

In addition, in some scenarios, the first predicted makeup may be implemented using a single image. This image can represent makeups of a plurality of face regions.

Through research, it has been found that the makeups of different regions of the face are independent of each other. Therefore, in order to enhance the makeup determining effect, the present application further provides a possible implementation of the above first predicted makeup. In this implementation, when the above target image is used for describing the makeup of the at least one region of the first face, the first predicted makeup may include a makeup extraction image corresponding to the at least one region. A makeup extraction image corresponding to an m-th region is a makeup prediction result determined for the m-th region using the first model, so that the makeup extraction image corresponding to the m-th region is used for describing a predicted makeup of the m-th region in the target image, m being a positive integer, m≤M, and M being a positive integer. M represents a number of regions among the at least one region.

In addition, the present application does not limit the obtaining method for the above first predicted makeup, for example, which may specifically include: inputting the target image to the first model, to cause the first model to perform makeup prediction (such as makeup extraction) on the target image, and obtaining and outputting the first predicted makeup, such as prediction result 1 shown in FIG. 2. The first predicted makeup may represent a result obtained after a first stage of processing is performed on the target image.

Based on the relevant content of S2 above, as can be seen, for some scenarios, after the target image, such as the rotation result shown in FIG. 2, is obtained, the first model may perform makeup extraction on the target image to obtain the first predicted makeup, such as prediction result 1 shown in FIG. 2. The first predicted makeup may represent a predicted makeup that is obtained by the first stage of processing and is of the first face in the target image, so that a makeup extraction result of the target image can be determined subsequently based on the first predicted makeup.

S3: The target image and the first predicted makeup are processed using a second model, to obtain a second predicted makeup.

The second model is a pre-trained machine learning model using a makeup prediction (such as makeup optimization) function, so that the first model can be used for predicting (such as performing makeup optimization on) input data of the second model, so that the present application can use the second model to implement a second stage of processing (such as makeup optimization).

In addition, the present application does not limit the implementation of the above second model above. For example, the first model may be implemented with any existing or future machine learning model with prediction performance.

In addition, in order to better enhance the makeup determining effect, the present application further provides a possible implementation of the above second model. In this implementation, the second model may at least satisfy the following constraints: a network structure of the second model is the same as a network structure of the first model, and a network parameter of the second model is different from a network parameter of the first model, so as to ensure that the two models have an adaptability as high as possible on the premise of having different functions. Thus, the second model can better optimize output data of the first model, which is conducive to enhancing the makeup determining effect. For ease of understanding, the following will make an explanation to some possible implementations.

In a possible implementation, in order to better reduce the randomness, when the input data of the above first model does not include a randomly generated noise image, the above second model may at least satisfy the following constraint: Input data of the second model does not include a randomly generated noise image either. This can effectively reduce the randomness of the makeup prediction process, thus helping to enhance the makeup determining effect.

In another possible implementation, in order to better reduce the randomness, when the processing process implemented using the first model does not include the process of performing denoising in the random direction, the above second model may at least satisfy the following constraint: The processing process implemented using the second model (such as the process shown in S3) does not include the process of performing denoising in the random direction. This can effectively reduce the randomness of the makeup prediction process and then enhance the makeup determining effect.

Based on the content of the above two paragraphs, as can be seen, in a possible implementation, in order to better enhance the makeup determining effect, the above second model may be implemented with another machine learning model besides a diffusion model. Another machine learning model does not have the randomness defect presented by the diffusion model itself, so that another machine learning model can effectively overcome the defect caused by the randomness of the diffusion model, which is conducive to enhancing the makeup determining effect.

In addition, the present application does not limit the implementation of another machine learning model in the previous paragraph. For example, another machine learning model may be implemented using any Transformer-based model.

In addition, in a possible implementation, in order to better reduce overheads, such as time overheads and computing resource overheads, when the above first model is implemented using the SegFormer model, the above second model may also be implemented using the SegFormer model, such as a prediction model shown in FIG. 3, so that the second model may at least satisfy the following constraints: a network structure of the second model is the same as a network structure of the first model; a network parameter of the second model is different from a network parameter of the first model; input data of the second model does not include a randomly generated noise image; and a processing process implemented using the second model does not include a process of performing denoising in a random direction. Since the SegFormer model has low operation time consumption, training and reasoning time of the second model built based on the SegFormer model is low, which is conducive to reducing the time overheads and the computing resource overheads.

Moreover, the present application does not limit the training method for the above second model. For example, the training may be implemented with any existing or future model training method.

The second predicted makeup is a result obtained by processing the target image and output data (such as the above first predicted makeup) of the first model by the second model, so that the second predicted makeup may represent a predicted makeup that is determined by the second model and is of the first face in the target image. Thus, the second predicted makeup may better represent the predicted makeup of the first face in the target image.

It can be seen that in a possible implementation, the second predicted makeup may be an optimization result of the first predicted makeup, so that a difference between a makeup described by the second predicted makeup and a makeup presented in the target image is less than a difference between a makeup described by the first predicted makeup and the makeup presented in the target image, making the makeup described by the second predicted makeup closer to the makeup presented in the target image, and enabling the second predicted makeup to better restore the makeup presented in the target image. This is beneficial for enhancing the makeup determining effect.

In addition, in order to better enhance the makeup determining effect, the present application further provides a possible implementation of the second predicted makeup. In this implementation, the second predicted makeup may at least satisfy the following constraints: a number of details described by the second predicted makeup is greater than a number of details described by the first predicted makeup, so that the number of the details described by the second predicted makeup is as close as possible to a number of details presented in the target image, thereby effectively avoiding an impact such as makeup blurring caused by loss of a large number of details. This is conducive to enhancing the makeup determining effect.

In addition, in order to better enhance the makeup determining effect, the present application further provides a possible implementation of the above second predicted makeup. In this implementation, the second predicted makeup may at least satisfy the following constraints: for any detail of the makeup in the target image, an accuracy of the detail in the second predicted makeup is greater than an accuracy of the detail in the first predicted makeup, to cause the details described by the second predicted makeup is as close as possible to the details presented in the target image, so that the second predicted makeup can accurately restore the details presented in the target image as much as possible, which can effectively avoid an impact such as makeup distortion caused by inaccurate detail prediction. This is conductive to enhancing the makeup determining effect.

Furthermore, in order to better enhance the makeup determining effect, the present application further provides a possible implementation of the above second predicted makeup. In this implementation, the second predicted makeup may at least satisfy the following constraints: for any detail of the makeup in the target image, a similarity between a state of the detail in the second predicted makeup and a state of the detail in the target image is greater than a similarity between a state of the detail in the first predicted makeup and the state of the detail in the target image, to cause the second predicted makeup to restore the details presented in the target image as perfectly as possible, which can effectively avoid an impact caused by imperfect detail restoration. This is conductive to enhancing the makeup determining effect.

Furthermore, the present application does not limit the representation of the above second predicted makeup. For example, the representation of the second predicted makeup is similar to that of the above first predicted makeup.

As can be seen, in a possible implementation, when the above target image is used for describing the makeup of the at least one region of the first face, the second predicted makeup may include a makeup optimization image corresponding to the at least one region. A makeup optimization image corresponding to an m-th region is a makeup optimization result determined using the second model for the m-th region, so that the makeup optimization image corresponding to the m-th region is used for better describing a predicted makeup of the m-th region in the target image in an image manner, m being a positive integer, m≤M, and M being a positive integer. M represents a number of regions among the at least one region.

In addition, the present application does not limit the implementation of S3 above. For example, S3 may specifically include: inputting the target image and the first predicted makeup into the second model, to cause the second model to perform makeup optimization based on the target image and the first predicted makeup, and obtaining and outputting the second predicted makeup. The makeup described by the second predicted makeup is closer to the makeup presented in the target image. This is conducive to enhancing the makeup determining effect.

In some scenarios, such as a scenario in which a number of channels of the input data of the second model is fixed, in order to better meet size requirements of these scenarios, the present application further provides a possible implementation of S3 above. In this implementation, when the above target image is used for describing the makeup of the at least one region of the first face, and the above first predicted makeup includes the makeup extraction image corresponding to the at least one region, S3 can specifically include: first, concatenating the target image and the makeup extraction image corresponding to the at least one region to obtain a concatenated result, implementing a number of channels of the concatenated result=a number of channels of the target image+ a number of channels of a makeup extraction image corresponding to a 1-st region+ a number of channels of a makeup extraction image corresponding to a 2-nd region+. . . (and so on)+ a number of channels of a makeup extraction image corresponding to an M-th region, M being a positive integer, and M representing a number of regions among the at least one region; then, performing convolution processing on the concatenated result to obtain a processing result, to cause a number of channels of the processing result to meet a size requirement of the input data of the second model, such as a requirement of the number of the channels of the processing result= the number of the channels of the target image= a number of channels of a makeup extraction image corresponding to each region; and finally, inputting the processing result to the second model, to cause the second model to perform makeup optimization (such as detail optimization) according to the processing result, and obtaining and outputting the second predicted makeup, so that the makeup described by the second predicted makeup is closer to the makeup presented in the target image. This is conductive to enhancing the makeup determining effect.

Through research, it has been found that in some scenarios, such as a scenario in which a high requirement is raised for the makeup determining effect, a makeup that meets this requirement may not be obtained only through one instance of optimization. Therefore, in order to better meet this requirement, a plurality of instances of optimization may be implemented in an iterative manner to obtain a more accurate makeup.

Based on the research in the previous paragraph, as can be seen, in a possible implementation, in order to better enhance the makeup determining effect, S3 above may specifically include step 21 to step 23 below.

Step 21: Input data of the second model is initialized based on the target image and the first predicted makeup.

It should be noted that the present application does not limit the implementation of step 21 above. For ease of understanding, an explanation will be made below in combination of two examples.

In Example 1, in some scenarios, such as a scenario in which a number of channels of the input data of the second model is not fixed. Step 21 above may be: using the target image and the first predicted makeup as initial values of the input data of the second model. The initial values include the target image and the first predicted makeup.

In Example 2, in some scenarios, such as a scenario in which a number of channels of the input data of the second model is fixed. Step 21 above may be: first concatenating the target image with the preset predicted makeup to obtain a concatenated result; then performing convolution processing on the concatenated result to obtain an initial value of the input data of the second model. The initial value includes a processing result of the convolution processing.

Based on the above two examples, as can be seen, in a possible implementation, step 21 above may specifically include step 211 to step 212 below.

Step 211: a target makeup is initialized using the first predicted makeup, to cause an initial value of the target makeup to include the first predicted makeup. The target makeup is used for representing data that needs to be optimized in a current round, so that the input data for the second model may be updated later by updating the target makeup.

Step 212: The input data of the second model is determined based on the target image and the target makeup.

It should be noted that the present application does not limit the implementation of step 212 above. For example, in some scenarios, step 212 may include: taking the target image and the target makeup as the input data of the second model, to cause the input data of the second model to include the target image and the target makeup.

For another example, in some other scenarios, when the above target makeup includes at least one image (such as the makeup extraction image corresponding to the at least one region of the above first face), and the at least one image is used for describing the predicted makeup of the first face in the target image, step 212 above may include: first concatenating the target image with the target makeup to obtain a concatenated result, wherein a number of channels of the concatenated result is determined based on a sum of a number of channels of the target image and a number of channels of the at least one image, for example, the number of the channels of the concatenated result is equal to the sum; then performing convolution processing on the concatenated result to obtain the input data of the second model, to cause the input data of the second model to include a convolution result, wherein a number of channels of the input data of the second model satisfies a number-of-channel constraint of the second model, such as the number of the channels of the input data of the second model=the number of the channels of the target image= a number of channels of each image.

Based on the relevant contents of step 211 to step 212 above, as can be seen, for some scenarios, after the first predicted makeup output by the first model for the target image, the first predicted makeup may be first used to initialize the target makeup, to cause the initial value of the target makeup to include the first predicted makeup; the input data of the second model is then determined based on the target image and the target makeup, so that the update for the input data of the second model can be completed later by updating the target makeup. This is conductive to improving efficiency.

Step 22: the input data of the second model is processed using the second model, to obtain output data of the second model, wherein the output data is used for describing a predicted makeup of the first face in the target image.

In the present application, for the current round, after the input data of the second model is obtained, the second model may be used to process the input data, such as makeup optimization, to obtain the output data of the second model, such as prediction result 2 in shown in FIG. 2, so that the output data may at least satisfy one or more of the following constraints: a number of details described by the output data is more than a number of details described by the input data; for any detail of the makeup in the target image, an accuracy of the detail presented by the output data is greater than an accuracy of the detail presented by the input data; and for any detail of the makeup in the target image, a similarity between a state of the detail in the output data and a state of the detail in the target image is greater than a similarity between a state of the detail in the input data and the state of the detail in the target image, so that the output data can better describe the predicted makeup of the first face in the target image.

Step 23: The input data of the second model is updated based on the output data of the second model, continue to perform step 22 above and its subsequent steps, and determine the second predicted makeup based on the output data of the second model when an iteration stop condition is satisfied.

The iteration stop condition means a condition that needs to be satisfied when the iteration stops. For example, a number of iterations is equal to 2.

In addition, the present application does not limit the implementation of the above iteration stop condition. For example, in some scenarios, in order to simplify the flow, the iteration stop condition may at least include: a number of iterations reaches a preset number-of-times threshold, and the number of iterations is in positive correlation with a number of times of use of the second model. The number of iterations is a number of times of optimization using the second model, so that the number of iterations is in positive correlation with the number of times of use of the second model. For example, the number of iterations may be equal to the number of times of use of the second model. It should be noted that the preset number-of-times threshold may be set according to an actual application scenario. Moreover, the present application does not limit the implementation of the preset number-of-times threshold, for example, the preset number-of-times threshold may be 2.

In addition, in order to better improve flexibility, the present application further provides a possible implementation of the above iteration stop condition. In this implementation, the iteration stop condition may at least include: a change rate of the output data of the second model is less than a first change rate threshold. The change rate is used for describe a change range between the output data of the second model in the current round and output data of the second model in a previous round, so that the change rate can indicate to an extent whether the output data of the second model in the current round has reached an optimal value with a minimum change rate. It should be noted that the first change rate threshold may be set according to an actual application scenario. Moreover, the present application does not limit the implementation of the first change rate threshold.

In addition, in order to better improve flexibility, the present application further provides a possible implementation of the above iteration stop condition. In this implementation, the iteration stop condition may at least include: a change rate of a difference between the output data of the second model and the above first predicted makeup is less than a second change rate threshold. The change rate is used for describing a change range between an optimization degree of the output data of the second model in the current round relative to the first predicted makeup and an optimization degree of the output data of the second model in the previous round relative to the first predicted makeup, so that the change rate can indicate an increase of the optimization in the current round, and the change rate can indicate to an extent whether the output data of the second model in the current round has reached an optimal value. It should be noted that the second change rate threshold may be set according to an actual application scenario. Moreover, the present application does not limit the implementation of the second change rate threshold.

Moreover, the present application does not limit the implementation of step 23 above of “Update the input data of the second model based on the output data of the second model”. For ease of understanding, an explanation will be made below in combination with two examples.

Example 1, in some scenarios, such as a scenario in which a number of channels of the input data of the second model is not fixed, the process of updating the input data of the above second model may be: using the target image and the output data of the second model as an update result of the input data of the second model, to cause the update result to include the target image and the output data of the second model.

In Example 2, in some scenarios, such as a scenario in which a number of channels of the input data of the second model is fixed, the process of updating the input data of the above second model may be: first concatenating the target image with the output data of the second model to obtain a concatenated result; then performing convolution processing on the concatenated result to obtain an update result of the input data of the second model, to cause the update result to include a processing result of the convolution processing.

As can be seen, in a possible implementation, when the input data of the above second model is determined with step 211 to step 212 above, step 23 above may specifically be: updating the target makeup based on the output data of the second model, continuing to perform step 212 above and its subsequent steps, and determining the second predicted makeup based on the output data of the second model when an iteration stop condition is satisfied.

Based on the content of the previous paragraph, as can be seen, in some scenarios, for the current round, after the output data of the second model is obtained, the target makeup may be updated using the output data of the second model, so that the updated target makeup includes the output data of the second model, and the updated target makeup can better indicate the details of the makeup in the target image. It is convenient to subsequently perform a next round of processing (such as makeup optimization) based on the updated target makeup, and so on, until the iteration stop condition is satisfied.

In addition, the present application does not limit the implementation of step 23 above of “Determine the second predicted makeup based on the output data of the second model”. For example, this step may be as follows: For the current round, after the output data of the second model is obtained, the output data of the second model may be determined as the second predicted makeup, so that the second predicted makeup can represent multi-round iterative optimization results of the first predicted makeup, and the second predicted makeup can better restore the makeup presented in the target image. This is conducive to enhancing the makeup determining effect.

Based on the relevant content of step 21 to step 23 above, as can be seen, in some scenarios, such as a scenario in which a high requirement is raised for the makeup determining effect, after the first predicted makeup output by the first model for the target image is obtained, the second model is used to implement a plurality of rounds of iterative optimization on the first predicted makeup, to obtain the second predicted makeup, so that the second predicted makeup may restore the makeup presented in the target image as perfectly as possible. This is conducive to enhancing the makeup determining effect.

S4 A makeup extraction result of the target image is determined based on the second predicted makeup.

The makeup extraction result of the target image is used for describing a makeup presented in the target image.

In addition, the present application does not limit the representation of the makeup extraction result of the above target image. For example, it is similar to the representation of the above first predicted makeup.

As can be seen, in a possible implementation, when the above target image is used for describing the makeup of the at least one region in the first face, the makeup extraction result of the target image may include the makeup extraction result of the at least one region. The makeup extraction result of the m-th region is data that is extracted from the target image and is used for describing the makeup of the m-th region, such as image data, so that the makeup extraction result of the m-th region may be used for describing the makeup of the m-th region in the target image, m being a positive integer, m≤M, and M being a positive integer.

Based on the relevant content of S1 to S4 above, for the makeup extraction method provided in the present application, a target image is first obtained, wherein the target image includes a first face and a makeup for decorating the first face; the target image is then processed using a first model, to obtain a first predicted makeup, wherein the first predicted makeup can describe some makeup details in the target image; the target image and the first predicted makeup are then processed using a second model, to obtain a second predicted makeup, wherein the second predicted makeup can more comprehensively and more accurately describe makeup details in the target image; and finally, a makeup extraction result of the target image is determined based on the second predicted makeup, wherein the makeup extraction result can comprehensively and accurately describe the makeup in the target image, which is beneficial for enhancing a makeup determining result.

In addition, the present application does not limit an executive body of the makeup extraction method according to this embodiment of the present application. For example, the makeup extraction method according to this embodiment of the present application may be applied to a terminal device or a server. For another example, the makeup extraction method according to this embodiment of the present application may also be implemented by a data interaction process between a terminal device or a server. The terminal device may be a smart phone, a computer, a personal digital assistant (PDA), a tablet computer, or the like. The server may be an independent server, a cluster server, or a cloud server.

In addition, in some scenarios, such as a makeup transfer scenario or a makeup replication scenario, makeup extraction is required, and the extracted makeup needs to be used to decorate faces described in other images.

In order to better meet the requirements shown in the previous paragraph, the present application further provides a possible implementation of the above makeup extraction method. In this implementation, when the target image is used for describing a makeup of at least one region in the first face. The at least one region includes one or more of eyelashes, an eye socket, an eyeball, cheeks, and a mouth, and when the makeup extraction result of the target image includes makeup extraction results of the regions, the makeup extraction method may further include step 31 below.

Step 31: For any face image, the makeup extraction results of some or all of regions of the above at least one region to the face image are superimposed, to obtain a superimposed image, wherein makeups of the superimposed image presented in the portion or all of the regions are kept consistent with makeups of the target image presented in the portion or all of the regions.

The face image is any image that requires makeup modification.

In addition, the present application does not limit the implementation of the face image. For example, the face image may be implemented with any image for describing a face without makeup.

For another example, in some scenarios, such as a makeup filling scenario, the face image may at least satisfy the following constraint: a makeup for decorating the above “the portion or all of the regions” does not exist in the face image, so that subsequent makeup adding can be implemented for these regions with step 31.

Based on the relevant content of step 31 above, as can be seen, in some scenarios, makeup extraction results of some face regions may be determined from a made-up image. Then, the makeup extraction results of these regions are directly superimposed onto another image, to obtain a superimposed image, so that makeups of the superimposed image presented in these regions are consistent with the makeup presented in the made-up image, thus achieving makeup replication (or transfer). The makeup extraction result only describes a makeup of a face region, so that the makeup extraction result may be directly superimposed on any image, to effectively avoid a defect such as low flexibility during makeup replication (or transfer) implemented with image generation based on the made-up image and another image. This is conducive to improving makeup replication (or transfer) flexibility.

In some scenarios, the makeup extraction result of the above target image may be obtained by processing the target image through a makeup extraction model, and the makeup extraction model includes the first model and the second model. The makeup extraction model is used for processing input data of the makeup extraction model.

In addition, the present application does not limit the implementation of the above makeup extraction model. For example, the makeup extraction model can include the first model and the second model, so that the makeup extraction model may determine the makeup extraction result from the made-up image through two stages of processing.

As can be seen, in a possible implementation, the above makeup extraction method may specifically include: first obtaining a target image, wherein the target image includes a first face and a makeup for decorating the first face; then processing the target image using a first model in a target model, to obtain a first predicted makeup; then processing the target image and the first predicted makeup using a second model in the target model to obtain a second predicted makeup, wherein details described by the second predicted makeup are more accurate, and a makeup extraction result of the target image can be determined subsequently based on the second predicted makeup.

For another example, the above makeup extraction model may include the first model, a convolution module, and the second model. The convolution module is configured to: concatenate input data of the first model with output data of the first model to obtain a concatenated result, and then perform convolution processing on the concatenated result.

As can be seen, in a possible implementation, the above makeup extraction method may specifically include: first obtaining a target image, wherein the target image includes a first face and a makeup for decorating the first face; then processing the target image using a first model in a target model, to obtain a first predicted makeup; then concatenating the target image with the first predicted makeup using a convolution module in the target model to obtain a concatenated result, and then performing convolution processing on the concatenated result to obtain a processing result; finally, processing the processing result using a second model in the target model to obtain a second predicted makeup, wherein details described by the second predicted makeup are more accurate, and a makeup extraction result of the target image can be determined subsequently based on the second predicted makeup.

Moreover, the present application does not limit the process for training the above makeup extraction model. For example, the training may be implemented with any existing or future model training process.

In addition, in order to better enhance the makeup determining effect, the preset application further provides a possible implementation of the process of training the above makeup extraction model. In this implementation, when the makeup extraction model includes the first model and the second model, the process of training the makeup extraction model may include step 41 to step 42.

Step 41: The first model in the makeup extraction model is trained using the first image and tag information corresponding to the first image, wherein the first image includes a second face and a makeup for decorating the second face; and the label information corresponding to the first image is used for describing an actual makeup of the second face in the first image.

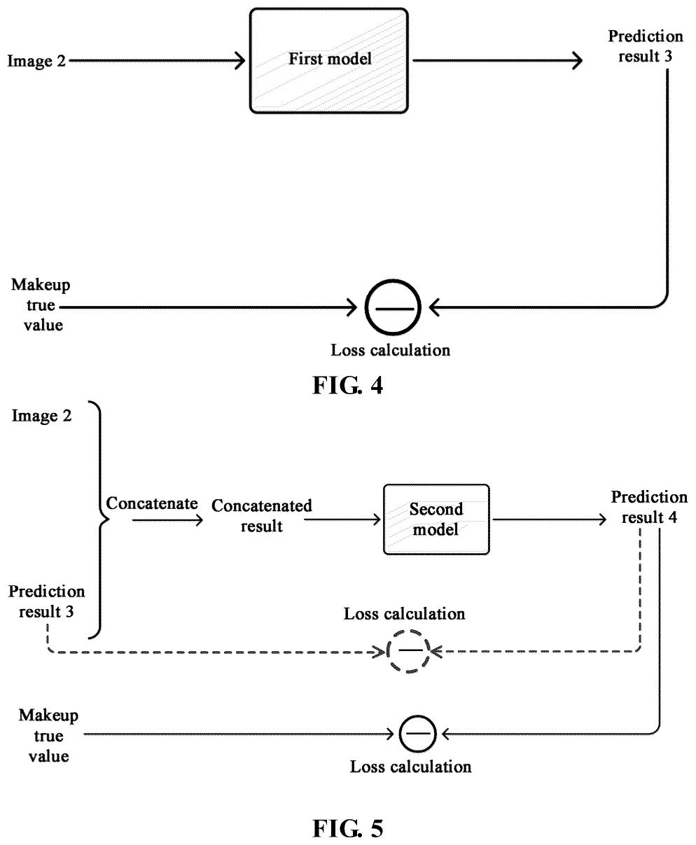

The first image is an image that needs to be used during the training of the first model, such as image 2 shown in FIG. 4. Furthermore, the face presented in the first image is in a made-up state.

As can be seen, in a possible implementation, the above first image may satisfy at least the following constraint: the first image includes a second face and a makeup for decorating the second face. The second face is a face presented in the first image. The “makeup for decorating the second face” is an object that is presented in the first image and is used for decorating the second face, so that the “makeup for decorating the second face” can reflect an effect implemented after the second face is made up.

In addition, the present application does not limit the obtaining method for the above first image. For example, when the above makeup extraction model is trained based on a training dataset, and the training dataset includes a plurality of sample images, the first image may be randomly selected from the training dataset, so that the plurality of sample images include the first image. The training dataset is a dataset that needs to be used during the training of the makeup extraction model.

In addition, the present application does not limit the implementation of the training dataset. For example, the training dataset may at least include a plurality of sample images, so that the training dataset may provide an image that requires makeup extraction in the process of training the makeup extraction model.

For another example, the above training dataset may include a plurality of sample images and label information corresponding to the sample images, so that the training dataset may not only provide an image that requires makeup extraction in the process of training the makeup extraction model, but also provide a makeup truth value of the image, so that the makeup extraction model can better learn how to perform makeup determination under the guidance of the makeup truth value.

Label information corresponding to an i-th sample image is used for describing an actual makeup of a face in the i-th sample image, so that the label information corresponding to the i-th sample image may be used as guidance information to guide the makeup extraction model to better learn makeup determination. Moreover, the present application does not limit the representation of the label information. For example, the representation of the label information is similar to the representation of the above first predicted makeup, i being a positive integer, i≤I, and I being a positive integer. I represents a number of the sample images.

Furthermore, the present application does not limit the obtaining method for the above training dataset. For example, the above training dataset may be obtained with any existing or future obtaining method for a training dataset. As can be seen, in a possible implementation, when the training dataset includes a plurality of sample images and label information corresponding to the sample images, these sample images may be images acquired in at least one manner, such as photo taking. Moreover, the label information corresponding to these sample images may be information obtained through manual annotation.

The obtaining method shown in the previous paragraph has the following defects: \textcircled{1} the manual annotation is implemented by specific personnel, the difficulty of obtaining training data is increased, thereby affecting a number of training data and resulting in poor generalization performance of a model trained based on the training data. \textcircled{2} Since some issues may arise during manual annotation, such as ignoring makeup details and annotation errors, the accuracy of the label information is reduced, thereby resulting in poor performance of a model trained based on the label information.

Based on the above research, in order to better improve the quality and number of the training dataset, the present application provides an obtaining method for the above training dataset. In this method, when the training dataset includes a plurality of sample images, for any sample image, the process of determining the sample image and the label information corresponding to the sample image may include: performing image generation first using an image generation model, to obtain a generated image, wherein the generated image includes a fourth face, and the generated image does not include a makeup for decorating the fourth face, so that the face described in the generated image is in a no-makeup state; and superimposing at least one makeup material obtained from a pre-built makeup library to the generated image, to obtain the sample image, wherein a face described in the sample image is in a made-up state; and determining the label information corresponding to the sample image according to the at least one makeup material, wherein the label information corresponding to the sample image includes the at least one makeup material. The at least one makeup material is a makeup material selected during the generation of the sample image, so that the at least one makeup material may represent an actual makeup of the face in the sample image, and the at least one makeup material may satisfy the following constraint: different makeup materials are used for decorating different face regions. In this way, the sample image generated based on the at least one makeup material can describe a makeup in one or more face regions.

It should be noted that the present application does not limit the implementation of the above at least one makeup material. For example, in order to ensure the generation quality, the at least one makeup material may satisfy the following constraint: face regions decorated by different makeup materials are different. In this way, a defect caused by various makeups existing in the same region can be avoided, and this is conductive to improving the generation quality.

The image generation model is used for performing image generation on input data of the image generation model. Moreover, the present application does not limit the implementation of the image generation model. For example, the image generation model may be implemented using any existing or future model using an image generation function, such as a Gan model or a diffusion model. For another example, in order to better enhance an image generation effect, the image generation model may be implemented with control net. It should be noted that the present application does not limit the implementation of the input data, for example, which may include one or more types of data such as images, text, and speech.

The generated image is an image obtained using the image generation model, causing the generated image to satisfy a constraint described by the input data of the image generation model, such as a style constraint, an identity document (ID) constraint, and a background constraint. Furthermore, the generated image may at least satisfy the following constraints: the generated image includes the fourth face, and the generated image does not include the makeup of the fourth face, so that the generated image is used for describing the fourth face that is in the no-makeup state (or non-made-up state). The fourth face is a face presented in the generated image.

The makeup library is a pre-built database for providing a large number of selectable makeups. As can be seen, in a possible implementation, the makeup library may include a plurality of makeup materials, so that one or more materials may be subsequently selected from these makeup materials for made-up image generation. The makeup material is a resource such as an image that exists in the makeup library and is used for describing a makeup in one or more regions of the face.

In addition, the present application does not limit the building method for the above makeup library. For example, the above makeup library may be built by manual annotation.

In addition, in order to better lower the data obtaining difficulty, the application further provides a building method for the above makeup library, which may specifically include: first obtaining a plurality of makeup effects from at least one application; then, for any makeup effect, adjusting at least one dimension of the makeup effect to obtain an adjustment result, wherein the adjustment result and the makeup effect have a difference in the at least one dimension, so that when the at least one dimension includes a color and/or a transparency, the adjustment result and the makeup effect has a difference in the color and/or the transparency, which can implement data enhancement in the at least one dimension; and finally, building the makeup library based on the plurality of makeup effects and the adjustment results. The makeup library includes the multiple makeup effects and the adjustment results.

As can be seen, for some scenarios, a plurality of makeup effects may be first obtained from some applications, so that the plurality of makeup effects can fully represent, as much as possible, makeups that can be implemented with the help of these applications. Then, the colors and/or transparencies of the makeup effects are adjusted to obtain enhancement data (such as the above adjustment results) of these makeup effects, so that the enhancement data and these makeup effects have differences, which is beneficial for improving makeup diversity. Afterwards, a makeup library is built according to these makeup effects and the enhancement data. The makeup library includes these makeup effects and the enhancement data, and can cover a variety of makeups as much as possible. Thus, the training dataset constructed based on the makeup library can cover a variety of makeups as much as possible. This makes the makeup extraction model obtained based on the training dataset suitable for extracting various makeups, which is beneficial for improving the generalization performance.

Based on the relevant content of the above training dataset, as can be seen, in some scenarios, the construction process of the training dataset may be as follows: Firstly, I pieces of image constraint information are randomly generated, such as a text condition, so that differences exist between different image constraint information, and the I pieces of image constraint information can cover, as much as possible, constraints that are satisfied by various faces. Then, the image generation model performs image generation based on i-th image constraint information to obtain an i-th generated image, so that a face presented in the i-th generated image satisfies the i-th image constraint information, i being a positive integer, i≤I. Thus, faces generated based on the I pieces of image constraint information can cover a variety of faces as many as possible, which is beneficial for improving the generalization performance. Finally, at least one makeup material (such as a lip makeup and an eye socket makeup) that is randomly selected from the pre-built makeup library is superimposed to the i-th generated image, to obtain an i-th sample image in the training dataset. The at least one randomly selected makeup material is determined as label information corresponding to the i-th sample image, i being a positive integer, i≤I. In this way, the training dataset can be obtained through automatic generation of makeup images, thereby effectively avoiding the defect caused by manually obtaining the training dataset.

Based on the relevant content of the above training dataset, as can be seen, in a possible implementation, when the training dataset includes a plurality of sample images and label information corresponding to the sample images, step 41 above may specifically include: after randomly selecting a first image and label information corresponding to the first image are randomly selected from the training dataset, training the first model in the makeup extraction model using the first image and the label information corresponding to the first image, to cause the first model to better learn how to perform makeup extraction. The first image includes a second face and a makeup for decorating the second face, and the label information corresponding to the first image is used for describing an actual makeup of the second face in the first image, so that the label information can subsequently guide the training process of the first model as a makeup truth value.

In addition, the present application does not limit the implementation of step 41 above. For example, step 41 may specifically include step 411 to step 412 below.

Step 411: the first image is processed using the first model to obtain predicted information corresponding to the first image, wherein the predicted information is used for describing a predicted makeup of the second face in the first image.

The predicted information corresponding to the first image is a result predicted for the first image using the first model, so that the predicted information can describe the predicted makeup of the second face in the first image.

In addition, the present application does not limit the representation of the predicted information corresponding to the above first image. For example, the representation is similar to the representation of the above first predicted makeup.

In addition, the present application does not limit the obtaining method for the predicted information corresponding to the above first image. For example, the obtaining method is similar to the obtaining method for the above first predicted makeup.

Based on the relevant content of step 411 above, as can be seen, for the current round, after the first image is obtained from the training dataset, the first image may be input to the first model to enable the first model to perform makeup extraction on the first image to obtain the predicted information corresponding to the first image, such as prediction result 3 shown in FIG. 4, so that the predicted information can describe the predicted makeup of the second face in the first image, and performance of the first model can be measured subsequently based on the predicted information.

Step 412: the first model in the makeup extraction model is updated based on a difference between the predicted information corresponding to the first image and the label information corresponding to the first image.

It should be noted that the present application does not limit the implementation of step 412 above. For example, it may specifically be: first performing loss calculation based on the difference between the predicted information corresponding to the first image and the label information corresponding to the first image, to obtain a model loss of the first model, to cause the model loss to represent the performance of the first model, such as makeup extraction performance; and then updating the first model in the above makeup extraction model according to the model loss, to cause the updated first model to have better performance.

In addition, in order to better improve performance of a model, the present application further provides a possible implementation of step 412 above. In this implementation, step 412 may include step 4121 to step 4123 below.

Step 4121: The predicted information corresponding to the first image is converted from a first color space to a second color space, to obtain a predicted conversion result corresponding to the first image, wherein the predicted conversion result is used for describing, in the second color space, a color presented by the predicted information corresponding to the first image.

The first color space is a color space, such as a red green blue (RGB) color space, in which an image (such as the predicted information corresponding to the first image or the label information corresponding to the first image) is located.

The second color space is a color space required for the loss calculation, such as a Lab color space. Moreover, the second color space at least satisfies the following constraint: a color change presented by the second color space is consistent with a color change perceived by a user, so that a makeup extraction model constructed based on the second color space can better learn the color change perceived by the user, which is beneficial for improving the performance of the model.

It should be noted that the full name of Lab is CIELAB, sometimes also written as CIE L*a *b*. CIE stands for international commission on illumination. In addition, Lab includes a brightness channel and two color channels. Furthermore, in the Lab color space, each color may be represented by three letters: L, a, and b, wherein L represents brightness; a represents a component from green to red; and b represents a component from blue to yellow. In addition, the Lab color space is designed based on a perception of a user to colors, so that a color change presented in the Lab color space is consistent with a color change perceived by the user. Further, the Lab color space is perceptually uniform. The Perceptual uniform means that if a magnitude of a change in L, a, or b is the same, a magnitude of a visual change brought to a user is almost the same. As can be seen, the Lab color space is more in line with human vision and easier to adjust compared with the RGB color space.

Step 4122: The label information corresponding to the first image is converted from the first color space to the second color space, to obtain a label conversion result corresponding to the first image, wherein the label conversion result is used for describing, in the second color space, a color presented by the label information corresponding to the first image.

It should be noted that the present application does not limit a relationship between execution time of step 4122 above and execution time of step 4121 above. For example, the two execution times are the same. For example, the former is earlier than the latter. For example, the latter is earlier than the former.

Step 4123: The first model in the makeup extraction model is updated based on a difference between the predicted conversion result corresponding to the first image and the label conversion result corresponding to the first image.

It should be noted that the present application does not limit the implementation of step 4123 above. For example, it may specifically be: first performing loss calculation based on the difference between the predicted conversion result corresponding to the first image and the label conversion result corresponding to the first image, such as lab-loss, to obtain a model loss of the first model, to cause the model loss to represent the performance of the first model; and then updating the first model in the above makeup extraction model according to the model loss, to cause the updated first model to have better performance. This is conductive to reducing a color difference predicted by a model.

Based on the relevant content of step 4121 to step 4123 above, as can be seen, for some scenarios, the loss calculation may be performed in the Lab color space according to the predicted information corresponding to the first image and the label information corresponding to the first image, so that the first model in the above makeup extraction model may be updated according to the calculated loss, and the updated first model has better performance. This is conducive to reducing a color difference predicted by a model.

Based on the relevant content of step 411 to step 412 above, for the first model in the above makeup extraction model, some or all of data in the training dataset may be used to train the first model, so that the trained first model can better learn how to perform makeup extraction from the training dataset, and the makeup extraction model including the first model has better performance.

In addition, in order to improve the performance, model training can be performed through a plurality of iterations. Based on this, as can be seen, in a possible implementation, step 41 above may specifically include step 413 to step 415 below.

Step 413: The first image and the label information corresponding to the first image are obtained from the training dataset, wherein the first image includes the second face and the makeup for decorating the second face, and the label information corresponding to the first image is used for describing the actual makeup of the second face in the first image.

It should be noted that the present application does not limit the implementation of step 413 above. For example, this step may specifically be: randomly selecting a sample image from the training dataset as the first image, and searching the training dataset for the label information corresponding to the sample image as the label information corresponding to the first image.

Step 414: The first image is processed using the first model, to obtain predicted information corresponding to the first image, wherein the predicted information is used for describing a predicted makeup of the second face in the first image.

It should also be noted that for the relevant content of step 414 above, refer to the relevant content of step 411 above.

Step 415: the first model in the makeup extraction model is updated based on a difference between the predicted information corresponding to the first image and the label information corresponding to the first image, and continue to perform step 413 above and its subsequent steps until a first stop condition is satisfied.

The first stop condition is a condition needing to be satisfied to end the iterative training for the first model.

In addition, the present application does not limit the implementation of the first stop condition. For example, the first stop condition may include: the model loss of the first model is less than a first loss threshold. For another example, the first stop condition may include: a change rate of the model loss of the first model is less than a third change rate threshold. For still another example, the first stop condition may include: a number of updates on the first model reaches a first number-of-times threshold.

Based on the relevant content of step 413 to step 415 above, in some scenarios, the first model in the makeup extraction model may be trained in an iterative manner, to cause the trained first model to have better makeup extraction performance, so that the makeup extraction model including the first model also has better performance.

Based on the relevant content of step 41 above, in some scenarios, the first model in the above makeup extraction model may be trained separately according to the training dataset to implement a first training stage for the makeup extraction model, so as to ensure that the first model obtained through the first training stage has good performance, so that other parts in the makeup extraction model can be continued to be trained by freezing (or fixing) a parameter in the first model.

Step 42: the second model in the makeup extraction model is trained using the second image and label information corresponding to the second image, wherein the second image includes a third face and a makeup for decorating the third face; and the label information corresponding to the second image is used for describing an actual makeup of the third face in the second image.

The second image is an image that needs to be used during the training of the second model, such as image 2 shown in FIG. 5. Furthermore, the face presented in the second image is in a made-up state.

As can be seen, in a possible implementation, the above second image may satisfy at least the following constraint: the second image includes a third face and a makeup for decorating the third face. The third face is a face presented in the second image. The “makeup for decorating the third face” is an object that is presented in the second image and is used for decorating the third face, so that the “makeup for decorating the third face” can reflect an effect implemented after the third face is made up.

In addition, the present application does not limit a relationship between the above second image and the above first image. For example, the second image and the first image are different. For another example, in some scenarios, in order to better improve efficiency, the relationship may be that the second image and the first image are the same, so that data involved in the last round of training on the first model can be directly used later, such as the predicted information corresponding to the first image, and data input for each round of training on the second model is generated. This is conducive to reducing the overheads, such as time overheads and computing resource overheads, thus enhancing a training effect.

In addition, the present application does not limit the obtaining method for the above second image. For example, the obtaining method for the second image is similar to the obtaining method for the above first image. For the sake of brevity, this will not be elaborated here. As can be seen, when the above makeup extraction model is trained based on a training dataset, and the training dataset at least includes a plurality of sample images, the second image may be randomly selected from the training dataset, so that the plurality of sample images include the second image. For the relevant content of the training dataset, refer to the above text.

As can be seen, in a possible implementation, when the above training dataset includes a plurality of sample images and label information corresponding to the sample images, step 42 above may specifically include: after randomly selecting a second image and label information corresponding to the second image are randomly selected from the training dataset, training the second model in the makeup extraction model using the second image and the label information corresponding to the second image, to cause the second model to better learn how to perform makeup extraction. The second image includes the third face and the makeup for decorating the third face, and the label information corresponding to the second image is used for describing the actual makeup of the third face in the second image, so that the label information can be subsequently used as a makeup truth value to guide the training process of the second model.

In addition, the present application does not limit the implementation of step 42 above. For example, step 42 may specifically include step 421 to step 423 below.

Step 421: The second image is trained using the trained first model, to obtain first predicted information corresponding to the second image, such as prediction result 3 shown in FIG. 5, wherein the first predicted information is used for describing a makeup prediction result output by the first model for the second image, and the first predicted information can represent a predicted makeup of the third face in the second image.

The first predicted information corresponding to the second image is a result predicted using the first model for the second image, so that the first predicted information can describe the predicted makeup of the third face in the second image.

In addition, the present application does not limit the representation of the first predicted information corresponding to the above second image, for example, it is similar to the representation of the above first predicted makeup.

In addition, the present application does not limit the obtaining method for the first predicted information corresponding to the above second image. For example, the obtaining method is similar to the obtaining method for the above first predicted makeup.

Step 422: the second image and the above first predicted information are processed using the second model, to obtain second predicted information corresponding to the second image, wherein the second predicted information is used for representing a makeup prediction result output by the second model for the second image, such as an optimization result for the first predicted information, so that the second predicted information is used for describing a predicted makeup of the third face in the second image.

The second predicted information corresponding to the second image is a result predicted using the second model for the second image, so that the second predicted information can describe the predicted makeup of the third face in the second image.

In addition, the present application does not limit the representation of the second predicted information corresponding to the above second image, for example, it is similar to the representation of the above first predicted makeup.

In addition, the present application does not limit the obtaining method for the second predicted information corresponding to the above second image. For example, the obtaining method is similar to the obtaining method for the above second predicted makeup.

Step 423: The second model in the makeup extraction model is updated based on a difference between the second predicted information corresponding to the second image and the label information corresponding to the second image.

It should be noted that the present application does not limit the implementation of step 423 above. For example, it may specifically be: first performing loss calculation based on the difference between the second predicted information corresponding to the second image and the label information corresponding to the second image, to obtain a model loss of the second model, to cause the model loss to represent the performance of the second model, such as makeup extraction performance; and then updating the second model in the above makeup extraction model according to the model loss, to cause the updated second model to have better performance.

In addition, in order to better improve performance of a model, the present application further provides a possible implementation of step 423 above. In this implementation, step 423 may include step 4231 to step 4233 below.

Step 4231: The second predicted information corresponding to the second image is converted from a first color space to a second color space, to obtain a conversion result corresponding to the second predicted information, wherein the conversion result is used for describing, in the second color space, a color presented by the second predicted information.

Step 4232: The label information corresponding to the second image is converted from the first color space to the second color space, to obtain a label conversion result corresponding to the second image, wherein the label conversion result is used for describing, in the second color space, a color presented by the label information corresponding to the second image.

It should be noted that the present application does not limit a relationship between execution time of step 4231 above and execution time of step 4232 above. For example, the two execution times are the same. For example, the former is earlier than the latter. For example, the latter is earlier than the former.

Step 4233: The second model in the makeup extraction model is updated based on a difference between the conversion result corresponding to the second predicted information and the label conversion result corresponding to the second image.

It should be noted that the present application does not limit the implementation of step 4123 above. For example, it may specifically be: first performing loss calculation based on the difference between the conversion result corresponding to the second predicted information and the label conversion result corresponding to the second image, such as lab-loss, to obtain a model loss of the second model, to cause the model loss to represent the performance of the second model; and then updating the second model in the above makeup extraction model according to the model loss, to cause the updated second model to have better performance. This is conductive to reducing a color difference predicted by a model.

Based on the relevant content of step 4231 to step 4233 above, as can be seen, for some scenarios, the loss calculation may be performed in the Lab color space according to the second predicted information corresponding to the second image and the label information corresponding to the second image, to obtain the model loss of the second model, so that the model loss can represent the performance of the second model more accurately; the second model in the above makeup extraction model may be updated according to the model loss, and the updated second model has better performance. This is conducive to reducing a color difference predicted by a model.

In addition, in order to better improve the makeup optimization performance, the present application further provides a possible implementation of step 423 above. In this implementation, step 423 may include: updating the second model in the makeup extraction model based on a difference between the second predicted information corresponding to the second image and the label information corresponding to the second image, and a difference between the second predicted information corresponding to the second image and the first predicted information corresponding to the second image, so that the updated second model has better makeup optimization performance.

In addition, the present application does not limit the implementation of step 423 in the previous paragraph. For example, step 423 may specifically include step 4234 to step 4237 below.

Step 4234: A first loss is determined based on the difference between the second predicted information corresponding to the second image and the label information corresponding to the second image, wherein the first loss is used for describing the makeup prediction performance of the second model.

It should be noted that the present application does not limit the implementation of step 4234 above. For example, it may specifically be: first performing loss calculation based on the difference between the second predicted information corresponding to the second image and the label information corresponding to the second image, to obtain the model loss.

For another example, in order to better enhance the training effect, step 4234 above may specifically include: first converting the second predicted information corresponding to the second image from the first color space to the second color space, to obtain an output conversion result corresponding to the second predicted information, and converting the label information corresponding to the second image from the first color space to the second color space, to obtain a label conversion result corresponding to the second image; and then performing loss calculation based on a difference between the conversion result corresponding to the second predicted information and the label conversion result corresponding to the second image, such as lab-loss, to obtain a first loss.

Step 4235: A second loss is determined based on the difference between the second predicted information corresponding to the second image and the first predicted information corresponding to the second image, wherein the second loss is used for describing the makeup optimization performance of the second model.

It should be noted that the present application does not limit the implementation of step 4235 above. For example, it may specifically be: first performing loss calculation based on the difference between the second predicted information corresponding to the second image and the first predicted information corresponding to the second image, to obtain the second loss.

For another example, in order to better enhance the training effect, step 4235 above may specifically include: first converting the second predicted information corresponding to the second image from the first color space to the second color space, to obtain a conversion result corresponding to the second predicted information, and converting the first predicted information corresponding to the second image from the first color space to the second color space, to obtain a conversion result corresponding to the first predicted information; and then performing loss calculation based on a difference between the conversion result corresponding to the second predicted information and the conversion result corresponding to the first predicted information, such as lab-loss, to obtain a second loss.

Step 4236: The model loss of the second model is determined based on a sum between the first loss and the second loss.

Step 4237: The second model in the makeup extraction model is updated according to the model loss of the second model, to cause the updated second model to have better makeup optimization performance.

Based on the relevant content of step 4234 to step 4237 above, in some scenarios, for the second model in the above makeup extraction model, in the training process of the second model, both the loss between the output data of the second model and the makeup true value and the loss between the output data of the second model and the makeup prediction result (such as the output data of the first model) input to the second model need to be considered, so that the second model can better learn how to perform makeup optimization (such as detail optimization) in the training process, so that the trained second model can better implement the makeup optimization effect.

Based on the relevant content of step 421 to step 423 above, for the second model in the above makeup extraction model, some or all of data in the training dataset may be used to train the second model, so that the trained second model can better learn how to perform makeup optimization from the training dataset.

In addition, in order to improve the performance, model training can be performed through a plurality of iterations. Based on this, as can be seen, in a possible implementation, step 42 above may specifically include step 424 to step 427 below.

Step 424: The second image and the label information corresponding to the second image are obtained from the training dataset, wherein the second image includes the third face and the makeup for decorating the third face, and the label information corresponding to the second image is used for describing the actual makeup of the third face in the second image.

It should be noted that the present application does not limit the implementation of step 424 above. For example, this step may specifically be: randomly selecting a sample image from the training dataset as the second image, and searching the training dataset for the label information corresponding to the sample image as the label information corresponding to the second image.

Step 425: the second image is processed using the trained first model, to obtain first predicted information corresponding to the second image, such as prediction result 3 shown in FIG. 5, wherein the first predicted information is used for describing a makeup prediction result output by the first model for the second image, and the first predicted information can represent a predicted makeup of the third face in the second image.

It should also be noted that for the relevant content of step 425 above, refer to the relevant content of step 421 above.

Step 426: The second image and the above first predicted information are processed using the second model, to obtain second predicted information corresponding to the second image, wherein the second predicted information is used for representing a makeup prediction result output by the second model for the second image, such as an optimization result for the first predicted information, so that the second predicted information is used for describing a predicted makeup of the third face in the second image.

It should also be noted that for the relevant content of step 426 above, refer to the relevant content of step 422 above.

Step 427: The second model in the makeup extraction model is updated based on a difference between the second predicted information corresponding to the second image and the label information corresponding to the second image, and continue to perform step 424 above and its subsequent steps until a second stop condition is satisfied.

The second stop condition is a condition needing to be satisfied to end the iterative training for the second model.

In addition, the present application does not limit the implementation of the second stop condition. For example, the second stop condition may include: the model loss of the second model is less than a second loss threshold. For another example, the second stop condition may include: a change rate of the model loss of the second model is less than a fourth change rate threshold. For still another example, the second stop condition may include: a number of updates on the second model reaches a second number-of-times threshold.

Based on the relevant content of step 424 to step 427 above, in some scenarios, the second model in the makeup extraction model may be trained in an iterative manner, to cause the trained second model to have better makeup extraction performance, so that the makeup extraction model including the second model also has good performance.

Based on the relevant content of step 42 above, in some scenarios, after the first model in the above makeup extraction model is trained separately according to the training dataset, a parameter in the first model may be frozen (or fixed), and the second model in the above makeup extraction model may continue to be trained according to the training dataset, so as to implement a second training stage for the makeup extraction model, so that only the parameter in the second model is updated in the second training stage, without updating the parameter in the first model, and the second model can better learn how to perform makeup optimization. When training data used in the training process of the second model is the same as training data used in the training process of the first model, the training process for the second model may be completed with data generated in the training process of the first model. This is conducive to saving overheads, such as time overheads and computing resource overheads, which is conductive to enhancing the training effect.

Based on the relevant content of step 41 to step 42 above, as can be seen, in some scenarios, the makeup extraction model may be trained according to the two training stages, so that the trained makeup extraction model can have better makeup determining performance, and the makeup extraction method implemented with the makeup extraction model has a good makeup determining effect.

Based on the relevant content of the above makeup extraction method, as can be seen, the technical solutions provided in the present application have the advantages shown in (1) to (3).

(1) The present application uses the makeup extraction model to implement the makeup extraction method. The makeup extraction model uses the two-stage processing method for makeup determination, so that the makeup extraction result obtained based on the makeup extraction model can better restore a makeup presented in a made-up image, which is conducive to improving the restoration degree of makeup details.

(2) The makeup extraction model overcomes a randomness defect of a diffusion model, so that the makeup extraction model is used to implement the makeup extraction method, which eliminates the randomness caused by a generation solution, and the makeup extraction method has a better makeup determining effect.

(3) The makeup extraction model uses a Transformer-based model, such as a SegFormer model, so that the makeup extraction model has a simple structure, which is conducive to significantly reducing the training and reasoning overheads, such as time overheads and computing resource overheads, of the model.

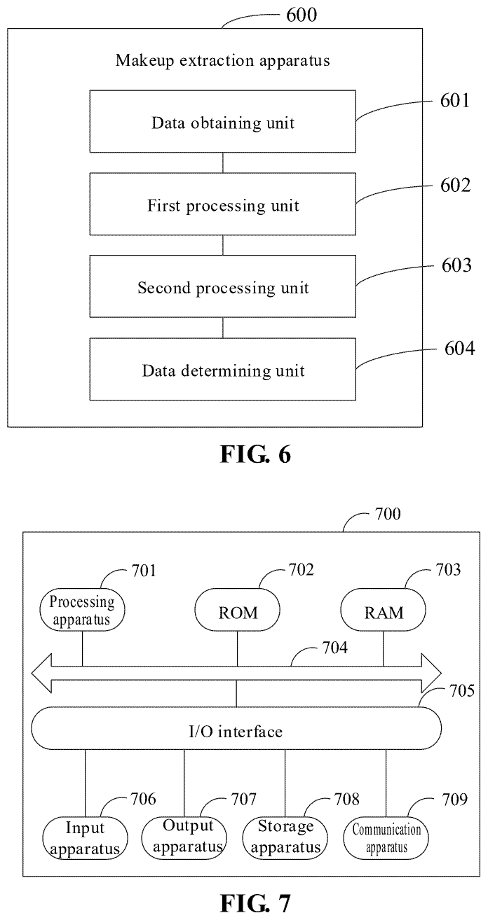

Based on the makeup extraction method according to this embodiment of the present application, an embodiment of the present application further provides a makeup extraction apparatus. The apparatus will be explained and described below in conjunction with FIG. 6. FIG. 6 is a schematic structural diagram of a makeup extraction apparatus according to an embodiment of the present application. It should be noted that for the technical details of the makeup extraction apparatus according to this embodiment of the present application, refer to the relevant content of the above makeup extraction method.

As shown in FIG. 6, the makeup extraction apparatus 600 according to this embodiment of the present application includes:
a data obtaining unit 601, configured to obtain a target image, wherein the target image includes a first face and a makeup for decorating the first face;
a first processing unit 602, configured to process the target image using a first model, to obtain a first predicted makeup;
a second processing unit 603, configured to process the target image and the first predicted makeup using a second model, to obtain a second predicted makeup; and
a data determining unit 604, configured to determine a makeup extraction result of the target image based on the second predicted makeup.

In a possible implementation, the second predicted makeup is an optimization result of the first predicted makeup.

In a possible implementation, the second predicted makeup satisfies at least one of the following constraints: a quantity of details described by the second predicted makeup is larger than a quantity of details described by the first predicted makeup; for any detail of the makeup in the target image, an accuracy of the detail in the second predicted makeup is greater than an accuracy of the detail in the first predicted makeup; and for any detail of the makeup in the target image, a similarity between a state of the detail in the second predicted makeup and a state of the detail in the target image is greater than a similarity between a state of the detail in the first predicted makeup and the state of the detail in the target image.

In a possible implementation, the second processing unit 603 is specifically configured to: initialize input data of the second model based on the target image and the first predicted makeup; process the input data of the second model using the second model, to obtain output data of the second model, wherein the output data is used for describing a predicted makeup of the first face in the target image; and update the input data of the second model based on the output data of the second model, continue to perform the step of processing the input data of the second model using the second model, and determine the second predicted makeup based on the output data of the second model when an iteration stop condition is satisfied.

In a possible implementation, the iteration stop condition includes at least one of the following conditions: a number of iterations reaches a preset number-of-times threshold, the number of iterations being in positive correlation with a number of times of use of the second model; a change rate of the output data of the second model is less than a first change rate threshold; and a change rate of a difference between the output data of the second model and the first predicted makeup is less than a second change rate threshold.

In a possible implementation, the second processing unit 603 is specifically configured to: initialize a target makeup using the first predicted makeup; determine the input data of the second model based on the target image and the target makeup; and update the target makeup based on the output data of the second model, and continue to perform the step of determining the input data of the second model based on the target image and the target makeup.

In a possible implementation, the target makeup includes at least one image; the at least one image is used for describing the predicted makeup of the first face in the target image; and the process of determining the input data of the second model includes: concatenating the target image with the target makeup to obtain a concatenated result, wherein a number of channels of the concatenated result is determined based on a sum of a number of channels of the target image and a number of channels of the at least one image; and performing convolution processing on the concatenated result to obtain the input data of the second model, wherein a number of channels of the input data of the second model satisfies a number-of-channel constraint of the second model.

In a possible implementation, the first model and the second model satisfy at least one of the following constraints: a network structure of the first model is the same as a network structure of the second model, and a network parameter of the first model is different from a network parameter of the second model; input data of the first model and the input data of the second model do not include a randomly generated noise image; and a processing process implemented using the first model and a processing process implemented using the second model do not include a process of performing denoising in a random direction.

In a possible implementation, the makeup extraction result is obtained by processing the target image by a makeup extraction model; the makeup extraction model includes the first model and the second model; and a process of training the makeup extraction model includes: training the first model in the makeup extraction model using the first image and label information corresponding to the first image, wherein the first image includes a second face and a makeup for decorating the second face; the label information corresponding to the first image is used for describing an actual makeup of the second face in the first image; and training the second model in the makeup extraction model using the second image and label information corresponding to the second image, wherein the second image includes a third face and a makeup for decorating the third face; the label information corresponding to the second image is used for describing an actual makeup of the third face in the second image.

In a possible implementation, a process of training the first model includes: processing the first image using the first model, to obtain predicted information corresponding to the first image, wherein the predicted information is used for describing a predicted makeup of the second face in the first image; and updating the first model in the makeup extraction model based on a difference between the predicted information corresponding to the first image and the label information corresponding to the first image.

In a possible implementation, the training process of the first model specifically includes: converting the predicted information corresponding to the first image from a first color space to a second color space, to obtain a predicted conversion result corresponding to the first image, and converting the label information corresponding to the first image from the first color space to the second color space, to obtain a label conversion result corresponding to the first image; updating the first model in the makeup extraction model based on a difference between the predicted conversion result corresponding to the first image and the label conversion result corresponding to the first image.

In a possible implementation, a process of training the second model includes: processing the second image using the first model, to obtain first predicted information corresponding to the second image, wherein the first predicted information is used for describing a predicted makeup of the third face in the second image; and processing the second image and the first predicted information using the second model, to obtain second predicted information corresponding to the second image, wherein the second predicted information is used for describing a predicted makeup of the third face in the second image; and updating the second model in the makeup extraction model based on a difference between the second predicted information and the label information corresponding to the second image.

In a possible implementation, the training process of the second model specifically includes: converting the second predicted information from a first color space to a second color space, to obtain a conversion result corresponding to the second predicted information, and converting the label information corresponding to the second image from the first color space to the second color space, to obtain a label conversion result corresponding to the second image; and updating the second model in the makeup extraction model based on a difference between the conversion result corresponding to the second predicted information and the label conversion result corresponding to the second image.

In a possible implementation, the training process of the second model specifically includes: updating the second model in the makeup extraction model based on a difference between the second predicted information and the label information corresponding to the second image, and a difference between the second predicted information and the first predicted information.

In a possible implementation, the makeup extraction model is trained based on a training dataset; the training dataset includes a plurality of sample images; the plurality of sample images include the first image and the second image; for any sample image, a process of determining the sample image and label information corresponding to the sample image includes: performing image generation using an image generation model, to obtain a generated image, wherein the generated image includes a fourth face, and the generated image does not include a makeup for decorating the fourth face; and superimposing at least one makeup material obtained from a pre-built makeup library to the generated image, to obtain the sample image, and determining the label information corresponding to the sample image according to the at least one makeup material, wherein different makeup materials are used for decorating different face regions.

In a possible implementation, a process of building the makeup library includes: obtaining a plurality of makeup effects from at least one application; for any makeup effect, adjusting at least one dimension of the makeup effect to obtain an adjustment result, wherein the at least one dimension includes a color and/or a transparency; and building the makeup library based on the plurality of makeup effects and the adjustment results.

In a possible implementation, the target image is used for describing a makeup of at least one region in the first face. The at least one region includes one or more of eyelashes, an eye socket, an eyeball, cheeks, and a mouth. The makeup extraction result of the target image includes makeup extraction results of the regions.

The makeup extraction apparatus 600 further includes: a makeup superimposition unit, configured to: for any face image, superimpose the makeup extraction results of some or all of regions of the at least one region to the face image, to obtain a superimposed image, wherein makeups of the superimposed image presented in the portion or all of the regions are kept consistent with makeups of the target image presented in the portion or all of the regions.

Based on the relevant content of the above makeup extraction apparatus 600, a working principle of the makeup extraction apparatus 600 provided in the present application includes: first obtaining a target image, wherein the target image includes a first face and a makeup for decorating the first face; then, processing the target image using a first model, to obtain a first predicted makeup, wherein the first predicted makeup can describe some makeup details in the target image; then, processing the target image and the first predicted makeup with a second model, to obtain a second predicted makeup, wherein the second predicted makeup can more comprehensively and more accurately describe makeup details in the target image; and finally, determining a makeup extraction result of the target image based on the second predicted makeup, wherein the makeup extraction result can comprehensively and accurately describe the makeup in the target image, which is beneficial for enhancing a makeup determining result.

In addition, an embodiment of the present application further provides an electronic device. The device includes a processor and a memory. The memory is configured to store an instruction or a computer program. The processor is configured to perform the instruction or the computer program stored in the memory to cause the electronic device to perform any implementation of the makeup extraction method according to the embodiments of the present application.

FIG. 7 shows a schematic structural diagram of an electronic device 700 suitable for implementing the embodiments of the present disclosure. A terminal device in this embodiment of the present disclosure may include, but is not limited to, a mobile terminal such as a mobile phone, a laptop computer, a digital broadcast receiver, a personal digital assistant (PDA), a portable android device (PAD), a portable media player (PMP), an in-vehicle terminal (for example, an in-vehicle navigation terminal), and a fixed terminal such as a digital television (TV) and a desktop computer. The electronic device shown in FIG. 7 is merely an example, and shall not impose any limitation on the function and scope of use of the embodiments of the present disclosure.

As shown in FIG. 7, the electronic device 700 may include a processing apparatus (for example, a central processing unit or a graphics processing unit) 701 that may perform a variety of appropriate actions and processing in accordance with a program stored in a read-only memory (ROM) 702 or a program loaded from a storage apparatus 708 into a random access memory (RAM) 703. Various programs and data that are required for operations of the electronic device 700 may also be stored in the RAM 703. The processing apparatus 701, the ROM 702, and the RAM 703 are connected to each other through a bus 704. An input/output (I/O) interface 705 is also connected to a bus 704.

Usually, following apparatuses can be connected to the I/ O interface 705: an input apparatus 706 including a touch screen, a touchpad, a keyboard, a mouse, a camera, a microphone, an accelerometer, a gyroscope, and the like; an output apparatus 707 including a liquid crystal display (LCD), a speaker, a vibrator, and the like; a storage apparatus 708 including a magnetic tape, a hard disk drive, and the like; and a communication apparatus 709. The communication apparatus 709 can allow the electronic device 700 to wirelessly or wiredly communicate with other devices to exchange data. Although FIG. 7 shows the electronic device 700 with multiple apparatuses, it should be understood that the electronic device 700 is not required to implement or have all the apparatuses shown, and can alternatively implement or have more or fewer apparatuses.

Particularly, according to the embodiments of the present disclosure, the process described in the reference flowchart above can be implemented as a computer software program. For example, the embodiments of the present disclosure include a computer program product, including a computer program carried on a non-transitory computer-readable medium, and the computer program includes program codes used for performing the methods shown in the flowcharts. In such an embodiment, the computer program may be downloaded and installed from a network through the communication apparatus 709, or installed from the storage apparatus 708, or installed from the ROM 702. When the computer program is performed by the processing apparatus 701, the above-mentioned functions defined in the methods of the embodiments of the present disclosure are performed.

The electronic device provided in this embodiment of the present application and the method provided in the above embodiment belong to the same concept. Technical details not fully described in this embodiment can be found in the above embodiment, and this embodiment has the same effects as the above embodiment.

An embodiment of the present application further provides a computer-readable medium, having an instruction or a computer program stored therein. When the instruction or the computer program is run on a device, the device is caused to perform any implementation of the makeup extraction method according to the embodiments of the present application.

It should be noted that the computer-readable medium mentioned in the present disclosure can be a computer-readable signal medium, a computer-readable storage medium, or any combination of the computer-readable signal medium and the computer-readable storage medium. The computer-readable storage medium can be, for example, but not limited to, electric, magnetic, optical, electromagnetic, infrared, or semiconductor systems, apparatuses, or devices, or any combination of the above. More specific examples of the computer-readable storage medium may include, but are not limited to: an electrical connection with one or more wires, a portable computer disk, a hard disk drive, a random access memory (RAM), a read-only memory (ROM), an erasable programmable read-only memory (EPROM) or flash memory, an optical fiber, a compact disc read-only memory (CD-ROM), an optical storage device, a magnetic storage device, or any suitable combination of the above. In the present disclosure, the computer-readable storage medium may be any tangible medium that contains or stores a program, and the program can be used by or in combination with an instruction execution system, apparatus, or device. In the present disclosure, the computer-readable signal media may include data signals propagated in a baseband or as part of a carrier wave, which carries computer-readable program codes. The propagated data signal may be in various forms, including but not limited to an electromagnetic signal, an optical signal, or any suitable combination thereof. The computer-readable signal medium may also be any computer-readable medium other than a computer-readable storage medium. The computer-readable signal medium can send, propagate, or transmit programs for use by or in combination with an instruction execution system, apparatus, or device. The program codes contained in the computer-readable medium can be transmitted using any suitable medium, including but are not limited to: a wire, an optical cable, a radio frequency (RF), and the like, or any suitable combination of the above.

In some implementations, clients and servers can communicate using any currently known or future developed network protocol such as a hypertext transfer protocol (HTTP), and can intercommunicate and be interconnected with digital data in any form or medium (for example, a communication network). Examples of the communication network include a local area network (LAN), a wide area network (WAN), an Internet network (e.g. an Internet), a point-to-point network (e.g. an ad hoc point-to-point network, and any currently known or future developed network.

The computer-readable medium may be included in the electronic device or exist alone and is not assembled into the electronic device.

The above computer-readable medium carries one or more programs. When run by the electronic device, the one or more programs cause the electronic device to implement the above method.

Computer program codes for performing the operations of the present disclosure may be written in one or more programming languages or a combination thereof. The above programming languages include but are not limited to an object-oriented programming language such as Java, Smalltalk, and C++, and conventional procedural programming languages such as “C” language or similar programming languages. The program codes may be performed entirely on a user computer, partly on a user computer, as a stand-alone software package, partly on a user computer and partly on a remote computer, or entirely on a remote computer or a server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowcharts and block diagrams in the accompanying drawings illustrate possible system architectures, functions, and operations that may be implemented by a system, a method, and a computer program product according to various embodiments of the present disclosure. In this regard, each block in a flowchart or a block diagram may represent a module, a program, or a part of a code. The module, the program, or the part of the code includes one or more executable instructions used for implementing specified logic functions. In some implementations used as substitutes, functions annotated in blocks may alternatively occur in a sequence different from that annotated in an accompanying drawing. For example, actually two blocks shown in succession may be performed basically in parallel, and sometimes the two blocks may be performed in a reverse sequence. This is determined by a related function. It is also be noted that each box in a block diagram and/or a flowchart and a combination of boxes in the block diagram and/or the flowchart may be implemented with a dedicated hardware-based system configured to perform a specified function or operation, or may be implemented with a combination of dedicated hardware and a computer instruction.

The units described in the embodiments of the present disclosure can be implemented through software or hardware. The names of the units/modules do not constitute a limitation on the units in a situation.

The functions described herein above may be performed, at least in part, by one or a plurality of hardware logic components. For example, and without limitation, example hardware logic components that can be used include: a field programmable gate array (FPGA), an application specific integrated circuit (ASIC), an application specific standard part (ASSP), a system on chip (SOC), a complex programmable logic device (CPLD), and the like.

In the context of the present disclosure, a machine-readable medium may be a tangible medium that may include or store a program for use by an instruction execution system, apparatus, or device or in connection with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above content. More specific examples of the machine-readable medium may include an electrical connection based on one or more wires, a portable computer disk, a hard disk drive, a RAM, a ROM, an EPROM or flash memory, an optical fiber, a CD-ROM, an optical storage device, a magnetic storage device, or any suitable combinations of the above contents.

It should be noted that the various embodiments in this specification are described in a progressive manner, and each embodiment focuses on differences from other embodiments. The same and similar parts between all the embodiments can be referred to each other. Since the system or apparatus disclosed in the embodiments correspond to the method disclosed in the embodiments, the apparatus is described simply, and related parts are found in some of the explanations of the method.

It should be understood that in the present application, “at least one” means one or more, and “plurality” means two or more. The term “and/or” is used for describing an association relationship of related objects, indicating that there are three types of relationships. For example, “A and/or B” can represent: only A exists, only B exists, and A and B exist simultaneously, where A and B can be singular or plural. The character “/” usually indicates an “or” relation between associated objects. The term “at least one of the following items” or its similar expression means any combination of these items, including any combination of a single item or a plurality of items. For example, at least one of a, b, or c can represent: a, b, c, “a and b”, “a and c”, “b and c”, or “a and b and c”, where a, b, and c can be singular or plural.

It should be further noted that in this document, relationship terms such as first and second are used solely to distinguish one entity or operation from another entity or operation without necessarily requiring or implying any actual such relationship or order between such entities or operations. Furthermore, the terms “include”, “including”, or any other variation thereof, are intended to encompass a non-exclusive inclusion, such that a process, method, article, or device that includes a list of elements does not include only those elements but may include other elements not explicitly listed or inherent to such process, method, article, or device. Without further limitation, an element defined by the phrase “including a/an...” does not exclude the presence of another identical elements in the process, method, article or device that includes the element.

The steps of the method or algorithm described in conjunction with the embodiments disclosed herein can be implemented directly using hardware, software modules performed by the processor, or a combination thereof. The software modules can be placed in a RAM, an internal memory, a ROM, an EPROM, EEPROM, a register, a hard disk drive, a removable disk, a CD-ROM, or a storage medium in any other form known in the technical field.

The above explanations of the disclosed embodiments enable those skilled in the art to implement or use the present application. The various modifications to these embodiments will be apparent to those skilled in the art, and the general principles defined herein can be implemented in other embodiments without departing from the spirit or scope of the present application. Thus, the present invention is not limited to these embodiments shown herein, but accords with the broadest scope consistent with the principles and novel features disclosed herein.

I/We claim:

1. A makeup extraction method, comprising:
obtaining a target image, the target image comprising a first face and a makeup for decorating the first face;
processing the target image using a first model to obtain a first predicted makeup;
processing the target image and the first predicted makeup using a second model to obtain a second predicted makeup; and
determining a makeup extraction result of the target image based on the second predicted makeup.

2. The method according to claim 1, wherein the second predicted makeup is an optimization result of the first predicted makeup; and/or,
the second predicted makeup satisfies at least one of the following constraints:
a quantity of details described by the second predicted makeup is larger than a quantity of details described by the first predicted makeup;
for any detail of the makeup in the target image, an accuracy of the detail in the second predicted makeup is greater than an accuracy of the detail in the first predicted makeup; and
for any detail of the makeup in the target image, a similarity between a state of the detail in the second predicted makeup and a state of the detail in the target image is greater than a similarity between a state of the detail in the first predicted makeup and the state of the detail in the target image.

3. The method according to claim 1, wherein a process of determining the second predicted makeup comprises:
initializing input data of the second model based on the target image and the first predicted makeup;
processing the input data of the second model using the second model to obtain output data of the second model, wherein the output data is used for describing a predicted makeup of the first face in the target image; and
updating the input data of the second model based on the output data of the second model, continuing to perform the step of processing the input data of the second model using the second model, and determining the second predicted makeup based on the output data of the second model in response to an iteration stop condition being satisfied.

4. The method according to claim 3, wherein the iteration stop condition comprises at least one of the following conditions:
a number of iterations reaches a preset number-of-times threshold, the number of iterations being in positive correlation with a number of times of use of the second model;
a change rate of the output data of the second model is less than a first change rate threshold; and
a change rate of a difference between the output data of the second model and the first predicted makeup is less than a second change rate threshold.

5. The method according to claim 3, before initializing the input data of the second model, further comprising:
initializing a target makeup using the first predicted makeup,
wherein initializing the input data of the second model based on the target image and the first predicted makeup comprises:
determining the input data of the second model based on the target image and the target makeup; and
wherein updating the input data of the second model based on the output data of the second model, and continuing to perform the step of processing the input data of the second model using the second model comprises:
updating the target makeup based on the output data of the second model, and continuing to perform the step of determining the input data of the second model based on the target image and the target makeup.

6. The method according to claim 5, wherein the target makeup comprises at least one image; the at least one image is used for describing the predicted makeup of the first face in the target image; and
the process of determining the input data of the second model comprises:
concatenating the target image with the target makeup to obtain a concatenated result, wherein a number of channels of the concatenated result is determined based on a sum of a number of channels of the target image and a number of channels of the at least one image; and
performing convolution processing on the concatenated result to obtain the input data of the second model, wherein a number of channels of the input data of the second model satisfies a number-of-channel constraint of the second model.

7. The method according to claim 1, wherein the first model and the second model satisfy at least one of the following constraints:
a network structure of the first model is the same as a network structure of the second model, and a network parameter of the first model is different from a network parameter of the second model;
input data of the first model and the input data of the second model both do not comprise a randomly generated noise image; and
a processing process implemented using the first model and a processing process implemented using the second model both do not comprise a process of performing denoising in a random direction.

8. The method according to claim 1, wherein the makeup extraction result is obtained by processing the target image by a makeup extraction model;
the makeup extraction model comprises the first model and the second model; and
a process of training the makeup extraction model comprises:
training the first model in the makeup extraction model using the first image and label information corresponding to the first image, wherein the first image comprises a second face and a makeup for decorating the second face; the label information corresponding to the first image is used for describing an actual makeup of the second face in the first image; and
training the second model in the makeup extraction model using the second image and label information corresponding to the second image, wherein the second image comprises a third face and a makeup for decorating the third face; the label information corresponding to the second image is used for describing an actual makeup of the third face in the second image.

9. The method according to claim 8, wherein a process of training the first model comprises:
processing the first image using the first model to obtain predicted information corresponding to the first image, wherein the predicted information is used for describing a predicted makeup of the second face in the first image; and
updating the first model in the makeup extraction model based on a difference between the predicted information corresponding to the first image and the label information corresponding to the first image.

10. The method according to claim 9, further comprising:
converting the predicted information corresponding to the first image from a first color space to a second color space to obtain a predicted conversion result corresponding to the first image, and converting the label information corresponding to the first image from the first color space to the second color space to obtain a label conversion result corresponding to the first image; and
wherein updating the first model in the makeup extraction model based on the difference between the predicted information corresponding to the first image and the label information corresponding to the first image comprises:
updating the first model in the makeup extraction model based on a difference between the predicted conversion result corresponding to the first image and the label conversion result corresponding to the first image.

11. The method according to claim 8, wherein a process of training the second model comprises:
processing the second image using the first model to obtain first predicted information corresponding to the second image, wherein the first predicted information is used for describing a predicted makeup of the third face in the second image; and
processing the second image and the first predicted information using the second model, to obtain second predicted information corresponding to the second image, wherein the second predicted information is used for describing a predicted makeup of the third face in the second image; and
updating the second model in the makeup extraction model based on a difference between the second predicted information and the label information corresponding to the second image.

12. The method according to claim 11, further comprising:
converting the second predicted information from a first color space to a second color space to obtain a conversion result corresponding to the second predicted information, and converting the label information corresponding to the second image from the first color space to the second color space to obtain a label conversion result corresponding to the second image; and
wherein updating the second model in the makeup extraction model based on the difference between the second predicted information and the label information corresponding to the second image comprises:
updating the second model in the makeup extraction model based on a difference between the conversion result corresponding to the second predicted information and the label conversion result corresponding to the second image.

13. The method according to claim 11, wherein updating the second model in the makeup extraction model based on the difference between the second predicted information and the label information corresponding to the second image comprises:
updating the second model in the makeup extraction model based on a difference between the second predicted information and the label information corresponding to the second image, and a difference between the second predicted information and the first predicted information.

14. The method according to claim 8, wherein the makeup extraction model is trained based on a training dataset; the training dataset comprises a plurality of sample images; the plurality of sample images comprise the first image and the second image;
for any sample image, a process of determining the sample image and tag information corresponding to the sample image comprises:
performing image generation using an image generation model to obtain a generated image, wherein the generated image comprises a fourth face, and the generated image does not comprise a makeup for decorating the fourth face; and
superimposing at least one makeup material obtained from a pre-built makeup library to the generated image to obtain the sample image, and determining the label information corresponding to the sample image based on the at least one makeup material, wherein different makeup materials are used for decorating different face regions.

15. The method according to claim 14, wherein a process of building the makeup library comprises:
obtaining a plurality of makeup effects from at least one application;
for any of the makeup effects, adjusting at least one dimension of the makeup effect to obtain an adjustment result, wherein the at least one dimension comprises a color and/or a transparency; and
building the makeup library based on the plurality of makeup effects and the adjustment results.

16. The method according to claim 1, wherein the target image is used for describing a makeup of at least one region in the first face; the at least one region comprises one or more of eyelashes, an eye socket, an eyeball, cheeks, and a mouth;
the makeup extraction result of the target image comprises makeup extraction results of the regions; and
after determining the makeup extraction result of the target image, the method further comprises:
for any face image, superimposing the makeup extraction results of a portion or all of regions of the at least one region to the face image, to obtain a superimposed image, wherein makeups of the superimposed image presented in the portion or all of the regions are kept consistent with makeups of the target image presented in the portion or all of the regions.

17. An electronic device, comprising a processor and a memory, wherein
the memory is configured to store an instruction or a computer program; and
the processor is configured to perform the instruction or the computer program in the memory to cause the electronic device to:
obtain a target image, the target image comprising a first face and a makeup for decorating the first face;
process the target image using a first model to obtain a first predicted makeup;
process the target image and the first predicted makeup using a second model to obtain a second predicted makeup; and
determine a makeup extraction result of the target image based on the second predicted makeup.

18. The device according to claim 17, wherein the second predicted makeup is an optimization result of the first predicted makeup; and/or,
the second predicted makeup satisfies at least one of the following constraints:
a quantity of details described by the second predicted makeup is larger than a quantity of details described by the first predicted makeup;
for any detail of the makeup in the target image, an accuracy of the detail in the second predicted makeup is greater than an accuracy of the detail in the first predicted makeup; and
for any detail of the makeup in the target image, a similarity between a state of the detail in the second predicted makeup and a state of the detail in the target image is greater than a similarity between a state of the detail in the first predicted makeup and the state of the detail in the target image.

19. The device according to claim 17, wherein the instructions causing the device to determine the second predicted makeup comprise the instructions causing the device to:
initialize input data of the second model based on the target image and the first predicted makeup;
process the input data of the second model using the second model to obtain output data of the second model, wherein the output data is used for describing a predicted makeup of the first face in the target image; and
update the input data of the second model based on the output data of the second model, continue to perform the step of processing the input data of the second model using the second model, and determine the second predicted makeup based on the output data of the second model in response to an iteration stop condition being satisfied.

20. A non-transitory computer-readable medium, having an instruction or a computer program stored therein, wherein the instruction or the computer program, when run on a device, causes the device to:
obtain a target image, the target image comprising a first face and a makeup for decorating the first face;
process the target image using a first model to obtain a first predicted makeup;
process the target image and the first predicted makeup using a second model to obtain a second predicted makeup; and
determine a makeup extraction result of the target image based on the second predicted makeup.
